(19) United States
(12) Patent Application Publication
(10) Pub. No.: US 2011/0053074 A1
(43) Pub. Date: Mar. 3, 2011

(54) CAPSULE TONER AND METHOD OF MANUFACTURING THE SAME

(76) Inventors: Takashi HARA, Osaka (JP); Yoshiaki Akazawa, Osaka (JP); Yoshitaka Kawase, Osaka (JP); Yoritaka Tsubaki, Osaka (JP); Yoshinori Mutoh, Osaka (JP); Keiichi Kikawa, Osaka (JP)

(21) Appl. No.: 12/862,000

(22) Filed: Aug. 24, 2010

(30) Foreign Application Priority Data
Aug. 28, 2009 (JP) P2009-199030
Mar. 23, 2010 (JP) P2010-067092

(51) Int. Cl. G03G 9/08

(52) U.S. Cl. 430/108.4; 430/137.13

(57) ABSTRACT

A capsule toner that a blocking resistance is improved without harming a low temperature fixation property, and a method of manufacturing the same are provided. A capsule toner includes a toner base particle containing a binder resin and a colorant, and a resin coating layer containing a crystalline polyester resin and an amorphous resin, the resin coating layer coating a surface of the toner base particle.

### CROSS-REFERENCE TO RELATED APPLICATION

This application claims priority to Japanese Patent Applications No. 2009-199030, which was filed on Aug. 28, 2009, and No. 2010-067092, which was filed on Mar. 23, 2010, the contents of which are incorporated herein by reference in their entirety.

### BACKGROUND OF THE INVENTION

1. Field of the Invention

The present invention relates to a capsule toner and a method of manufacturing the same.

2. Description of the Related Art

In an image forming apparatus employing an electrophotography, a surface of an image carrier is uniformly charged by a charging section (charging step), the surface of the image carrier is exposed by an exposure section to dissipate an electric charge of an exposed part so that an electrostatic latent image is formed on the surface of the image carrier (exposure step). Subsequently, a toner composed of pigmented fine powder having an electric charge is adhered to the electrostatic latent image to be visualized (developing step), and thus obtained visible image is transferred to a recording medium such as paper (transfer step). Further, the visible image is fixed on the recording medium by a fixing section by applying heat and pressure, or other fixing method (fixing step). Through the steps as described above, the image is formed on the recording medium. In addition, cleaning of the image carrier is performed for removing the toner remaining on the surface of the image carrier without being transferred to the recording medium (cleaning step).

A toner to be used for such image formation is necessary to include a function required not only for the developing step but also for each step of the transfer step, the fixing step, and the cleaning step.

Examples of a fixing method of a toner include a heating fixing method of fixing a toner on a recording medium by heating and melting, and a pressure fixing method of fixing a toner on a recording medium by plastically deforming it with pressure.

In the heating fixing method, in consideration of the simplification of a fixing device, image quality after fixation and the like, a heat roll fixing method using a heat roll as a heating medium to heat and melt a toner has often been used. In such a method, from a view point of energy conservation, a toner is required to be fixed on a recording medium by melting at the temperature as low as possible. Thereby, low temperature fixation property of the toner is required, and therefore, making smaller the molecular weight of a binder resin contained in the toner, and lowering a softening temperature of the toner by adding a release agent to the toner have been performed.

However, even though such a toner has the low temperature fixation property, under a high-temperature environment such as being left inside a sun-heated car, for example, there is a problem of degradation of blocking resistance in which a toner is softened by the heat to easily aggregate.

To solve such a problem, Japanese Unexamined Patent Publication JP-A 2005-266565 discloses a toner which has a core-shell structure containing a crystalline polyester resin in the core and containing an amorphous polymer resin as a main component in a shell layer.

However, in the toner disclosed in JP-A 2005-266565, since the core containing the crystalline polyester resin is coated by the shell layer composed of the amorphous polymer resin, even though the blocking resistance is able to be secured, there is a problem that the low temperature fixation property provided in the crystalline polyester resin is hampered, and the low temperature fixation property and the blocking resistance are not improved at the same time.

### SUMMARY OF THE INVENTION

Therefore, an object of the invention is to provide a capsule toner that the blocking resistance is improved without losing the low temperature fixation property, and a method of manufacturing the same.

The invention provides a capsule toner comprising:

a toner base particle containing a binder resin and a colorant; and

a resin coating layer containing a crystalline polyester resin and an amorphous resin, the resin coating layer coating a surface of the toner base particle.

According to the invention, since the capsule toner comprises a toner base particle, and a resin coating layer containing a crystalline polyester resin and an amorphous resin, the resin coating layer coating a surface of the toner base particle, the low temperature fixation property of the toner is able to be improved with the crystalline polyester resin, and at the same time, the blocking resistance of the toner is able to be improved with the amorphous resin.

Further, the invention provides a method of manufacturing a capsule toner, comprising:

a mixed fine resin particle adhering step of adhering mixed fine resin particles composed of a crystalline polyester fine resin particle and an amorphous fine resin particle to a surface of a toner base particle containing a binder resin and a colorant to form a base particle having fine resin particles adhered thereto;

a spraying step of spraying a liquid that plasticizes the mixed fine resin particles and the toner base particle to the base particle having fine resin particle adhered thereto made to be in a fluidized state; and

a film-forming step of performing the film-forming of the mixed fine resin particles by impact force to form a resin coating layer on the surface of the toner base particle.

According to the invention, to the toner base particle, and the mixed fine resin particles composed of the crystalline polyester fine resin particle and the amorphous fine resin particle, the liquid that plasticizes these particles is sprayed, and thereby, these particles are plasticized to be softened so that a resin coating layer is able to be formed on the surface of the toner base particle by small impact force. Further, the crystalline polyester fine resin particle is not heated to be at the boiling point or above of the spray liquid even in the case of being heated with the impact force, since the sprayed liquid takes away heat of evaporation in evaporating. Therefore, since it is possible to suppress the crystalline polyester resin particles whose viscosity is low to melt and exude from the resin coating layer, the blocking resistance of the toner is able to be improved.

Further, it is preferable that the mixed fine resin particle adhering step includes a step of preparing the mixed fine resin particles by mixing the crystalline polyester fine resin particle and the amorphous fine resin particle, and a step of mixing the toner base particle and the mixed fine resin particles to form a base particle having fine resin particle adhered thereto in which the mixed fine resin particles are adhered on the surface of the toner base particle.

According to the invention, since the mixed fine resin particle adhering step includes a step of preparing the mixed fine resin particles by mixing the crystalline polyester fine resin particle and the amorphous fine resin particle, and a step of mixing the toner base particle and the mixed fine resin particles to form a base particle having fine resin particle adhered thereto in which the mixed fine resin particles are adhered on the surface of the toner base particle, the fine resin particles which have been uniformly mixed in advance are adhered on the surface of the toner base particle to form a uniform resin coating layer. As the result, the low temperature fixation property and the blocking resistance of the toner is able to be improved more effectively.

Further, it is preferable that a volume median particle size of the crystalline polyester fine resin particles is smaller than a volume median particle size of the amorphous fine resin particles.

According to the invention, since the volume median particle size of the crystalline polyester fine resin particles is smaller than the volume median particle size of the amorphous fine resin particles, a structure in which exposure of the amorphous fine resin particle is more than that of the crystalline polyester fine resin particle is easily formed in the resin coating layer. Thereby, the blocking resistance of the toner is able to be enhanced more effectively.

Further, it is preferable that the mixed fine resin particles contain 20% by weight or more and 50% by weight or less of the crystalline polyester fine resin particle.

According to the invention, since the mixed fine resin particles contain 20% by weight or more and 50% by weight or less of the crystalline polyester fine resin particle, the low temperature fixation property and the blocking resistance of the toner are able to be improved at the same time.

Further, the invention provides a method of manufacturing a capsule toner, comprising:

an amorphous fine resin particle adhering step of adhering an amorphous fine resin particle on a surface of a toner base particle containing a binder resin and a colorant to form a base particle having an amorphous fine resin particle adhered thereto;

a spraying step of spraying a dispersion liquid to the base particle having the amorphous fine resin particle adhered thereto made to be in a fluidized state, the dispersion liquid being prepared by dispersing a crystalline polyester fine resin particle into a liquid that plasticizes the amorphous fine resin particle and the toner base particle; and

a film-forming step of performing the film-forming of the amorphous fine resin particle and the crystalline polyester fine resin particle by impact force to form a resin coating layer on the surface of the toner base particle.

According to the invention, since a dispersion liquid prepared by dispersing the crystalline polyester fine resin particle into a liquid that plasticizes the amorphous fine resin particle and the toner base particle, is sprayed to the base particle having the amorphous fine resin particle adhered thereto in which the amorphous fine resin particle is adhered on the surface of the toner base particle made to be in a fluidized state, a dispersion property of the crystalline polyester fine resin particle contained in the resin coating layer is improved so that the low temperature fixation property of the toner is able to be improved.

### BRIEF DESCRIPTION OF THE DRAWINGS

Other and further objects, features, and advantages of the invention will be more explicit from the following detailed description taken with reference to the drawings wherein:

FIG. 1 is a flowchart showing a method of manufacturing a capsule toner according to a first embodiment of the invention;

FIG. 2 is a front view showing a configuration of a toner manufacturing apparatus for using in an example of the method of manufacturing a capsule toner according to the invention;

FIG. 3 is a schematic sectional view of the toner manufacturing apparatus shown in FIG. 2 taken along a sectional line A200-A200;

FIG. 4 is a front view showing a configuration around the powder inputting section and the powder collecting section; and

FIG. 5 is a flowchart showing a method of manufacturing a capsule toner according to a second embodiment of the invention.

### DETAILED DESCRIPTION

Now referring to the drawings, preferred embodiments of the invention are described below.

1. Method for Manufacturing Toner

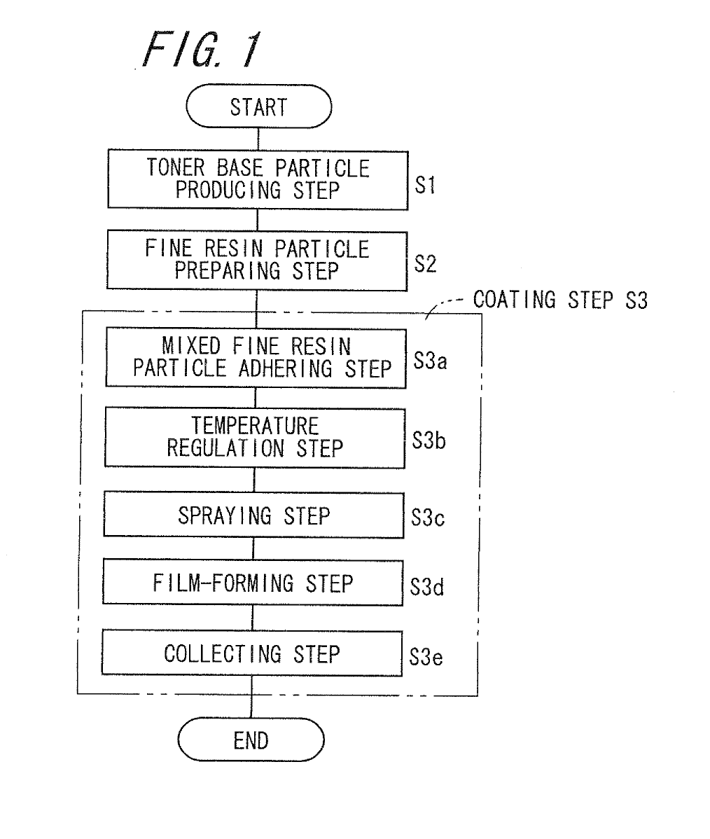

FIG. 1 is a flowchart showing a method of manufacturing a capsule toner according to a first embodiment of the invention. The method for manufacturing a capsule toner of the invention comprises a toner base particle producing step S1 of producing toner base particles, a fine resin particle preparing step S2 of preparing fine resin particles, and a coating step S3 of coating the toner base particle with the fine resin particles.

(1) Toner base particle producing step S1

At the toner base particle producing step S1, toner base particles to be coated with resin coating layers are produced. The toner base particle is a particle containing binder resin and a colorant, and a method of producing the toner base particles can be performed by a known method without particular limitation. Examples of the method of producing the toner base particles include a dry method such as a pulverization method, and a wet method such as a suspension polymerization method, an emulsion aggregation method, a dispersion polymerization method, a dissolution suspension method and a melting emulsion method. The method for producing the toner base particles using a pulverization method will be described below.

(Method of Producing Toner Base Particles by a Pulverization Method)

In a method of producing toner base particles using a pulverization method, a toner composition containing a binder resin, a colorant and other additives is dry-mixed by a mixer, and thereafter melt-kneaded by a kneading machine. The kneaded material obtained by melt-kneading is cooled and solidified, and then the solidified material is pulverized by a pulverizing machine. Subsequently, the toner base particles are optionally obtained by conducting adjustment of a particle size such as classification.

Usable mixers include heretofore known mixers including, for example, Henschel-type mixing devices such as HENSCHELMIXER (trade name) manufactured by Mitsui Mining Co., Ltd., SUPERMIXER (trade name) manufactured by Kawata MFG Co., Ltd., and MECHANOMILL (trade name) manufactured by Okada Seiko Co., Ltd., ANGMILL (trade name) manufactured by Hosokawa Micron Corporation, HYBRIDIZATION SYSTEM (trade name) manufactured by Nara Machinery Co., Ltd., and COSMOSYSTEM (trade name) manufactured by Kawasaki Heavy Industries, Ltd.

Usable kneaders include heretofore known kneaders including, for example, commonly-used kneaders such as a twin-screw extruder, a three roll mill, and a laboplast mill. Specific examples of such kneaders include single or twin screw extruders such as TEM-100B (trade name) manufactured by Toshiba Machine Co., Ltd., PCM-65/87 and PCM-30, both of which are trade names and manufactured by Ikegai, Ltd., and open roll-type kneading machines such as KNEADEX (trade name) manufactured by Mitsui Mining Co., Ltd. Among them, the open roll-type kneading machines are preferable.

Examples of the pulverizing machine include a jet pulverizing machine that performs pulverization using ultrasonic jet air stream, and an impact pulverizing machine that performs pulverization by guiding a solidified material to a space formed between a rotor that is rotated at high speed and a stator (liner).

For the classification, a known classifying machine capable of removing excessively pulverized toner base particles by classification with a centrifugal force or classification with a wind force is usable and an example thereof includes a revolving type wind-force classifying machine (rotary type wind-force classifying machine).

(Raw Materials of Toner Base Particles)

As described above, the toner base particles contain the binder resin and the colorant. The binder resin is not particularly limited and any known binder resin used for a black toner or a color toner is usable, and examples thereof include a styrene resin such as a polystyrene and a styrene-acrylic acid ester copolymer resin, an acrylic resin such as a polymethylmethacrylate, a polyolefin resin such as a polyethylene, a polyester, a polyurethane, and an epoxy resin. Further, a resin obtained by polymerization reaction induced by mixing a monomer mixture material and a release agent may be used. The binder resin may be used each alone, or two or more of them may be used in combination.

Among the binder resins, polyester is preferable as binder resin for color toner owing to its excellent transparency as well as good powder flowability, low temperature fixation property, and secondary color reproducibility. For polyester, heretofore known substances may be used including a polycondensation of polybasic acid and polyvalent alcohol.

For polybasic acid, substances known as monomers for polyester can be used including, for example: aromatic carboxylic acids such as terephthalic acid, isophthalic acid, phthalic anhydride, trimellitic anhydride, pyromellitic acid, and naphthalene dicarboxylic acid; aliphatic carboxylic acids such as maleic anhydride, fumaric acid, succinic acid, alkenyl succinic anhydride, and adipic acid; and methyl-esterified compounds of these polybasic acids. The polybasic acids may be used each alone, or two or more of them may be used in combination.

For polyvalent alcohol, substances known as monomers for polyester can also be used including, for example: aliphatic polyvalent alcohols such as ethylene glycol, propylene glycol, butenediol, hexanediol, neopentyl glycol, and glycerin; alicyclic polyvalent alcohols such as cyclohexanediol, cyclohexanedimethanol, and hydrogenated bisphenol A; and aromatic diols such as ethylene oxide adduct of bisphenol A and propylene oxide adduct of bisphenol A. The polyvalent alcohols may be used each alone, or two or more of them may be used in combination.

The polybasic acid and the polyvalent alcohol can undergo polycondensation reaction in an ordinary manner, that is, for example, the polybasic acid and the polyvalent alcohol are brought into contact with each other in the presence or absence of the organic solvent and in the presence of the polycondensation catalyst. The polycondensation reaction ends when an acid number, a softening temperature, etc. of the polyester to be produced reach predetermined values. The polyester is thus obtained.

When the methyl-esterified compound of the polybasic acid is used as part of the polybasic acid, demethanol polycondensation reaction is caused. In the polycondensation reaction, a compounding ratio, a reaction rate, etc. of the polybasic acid and the polyvalent alcohol are appropriately modified, thereby being capable of, for example, adjusting a content of a carboxyl end group in the polyester and thus allowing for denaturation of the polyester. The denatured polyester can be obtained also by simply introducing a carboxyl group to a main chain of the polyester with use of trimellitic anhydride as polybasic acid. Note that polyester self-dispersible in water may also be used which polyester has a main chain or side chain bonded to a hydrophilic radical such as a carboxyl group or a sulfonate group. Further, polyester may be grafted with acrylic resin.

It is preferred that the binder resin have a glass transition temperature of 30° C. or higher and 80° C. or lower. The binder resinhaving a glass transition temperature lower than 30° C. easily causes the blocking that the toner thermally aggregates inside the image forming apparatus, which may decrease preservation stability. The binder resin having a glass transition temperature higher than 80° C. lowers the fixing property of the toner onto a recording medium, which may cause a fixing failure.

As the colorant, it is possible to use an organic dye, an organic pigment, an inorganic dye, an inorganic pigment or the like which is customarily used in the field of electrophotography.

Examples of black colorant include carbon black, copper oxide, manganese dioxide, aniline black, activated carbon, non-magnetic ferrite, magnetic ferrite, and magnetite.

Examples of yellow colorant include yellow lead, zinc yellow, cadmium yellow, yellow iron oxide, mineral fast yellow, nickel titanium yellow, navel yellow, naphthol yellow 5, hanza yellow G, hanza yellow 10G, benzidine yellow G, benzidine yellow GR, quinoline yellow lake, permanent yellow NCG, tartrazine lake, C.I. Pigment Yellow 12, C.I. Pigment Yellow 13, C.I. Pigment Yellow 14, Pigment Yellow 15, C.I. Pigment Yellow 17, C.I. Pigment Yellow 93, C.I. Pigment Yellow 94, C.I. Pigment Yellow 138, C.I. Pigment Yellow 180, and C.I. Pigment Yellow 185.

Examples of orange colorant include red lead yellow, molybdenum orange, permanent orange GTR, pyrazolone orange, vulcan orange, indanthrene brilliant orange RK, benzidine orange G, indanthrene brilliant orange OK, C.I. Pigment Orange 31, and C.I. Pigment Orange 43.

Examples of red colorant include red iron oxide, cadmium red, red lead oxide, mercury sulfide, cadmium, permanent red 4R, lysol red, pyrazolone red, watching red, calcium salt, lake red C, lake red D, brilliant carmine 6B, eosin lake, rhodamine lake B, alizarin lake, brilliant carmine 3B, C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, and C.I. Pigment Red 222.

Examples of purple colorant includes manganese purple, fast violet B, and methyl violet lake.

Examples of blue colorant include Prussian blue, cobalt blue, alkali blue lake, Victoria blue lake, phthalocyanine blue, non-metal phthalocyanine blue, phthalocyanine blue-partial chlorination product, fast sky blue, Indanthrene blue BC, C.I. Pigment Blue 15, C.I. Pigment Blue 15:2, C.I. Pigment Blue 15:3, C.I. Pigment Blue 16, and C.I. Pigment Blue 60.

Examples of green colorant include chromium green, chromium oxide, pigment green B, malachite green lake, final yellow green G, and C.I. Pigment Green 7.

Examples of white colorant include those compounds such as zinc white, titanium oxide, antimony white, and zinc sulfide.

The colorants may be used each alone, or two or more of the colorants of different colors may be used in combination. Further, two or more of the colorants with the same color may be used in combination. A usage of the colorant is not limited to a particular amount, and preferably 5 parts by weight to 20 parts by weight, and more preferably 5 parts by weight to 10 parts by weight based on 100 parts by weight of the binder resin.

The colorant may be used as a masterbatch to be dispersed uniformly in the binder resin. Further, two or more kinds of the colorants may be formed into a composite particle. The composite particle is capable of being manufactured, for example, by adding an appropriate amount of water, lower alcohol and the like to two or more kinds of colorants and granulating the mixture by a general granulating machine such as a high-speed mill, followed by drying. The masterbatch and the composite particle are mixed into the toner composition at the time of dry-mixing.

The toner base particles may contain a charge control agent in addition to the binder resin and the colorant. For the charge control agent, charge control agents commonly used in this field for controlling a positive charge and a negative charge are usable.

Examples of the charge control agent for controlling a positive charge include a basic dye, a quaternary ammonium salt, a quaternary phosphonium salt, an aminopyrine, a pyrimidine compound, a polynuclear polyamino compound, an aminosilane, a nigrosine dye, a derivative thereof, a triphenylmethane derivative, a guanidine salt and an amidin salt.

Examples of the charge control agent for controlling a negative charge include an oil-soluble dye such as an oil black and a spirone black, a metal-containing azo compound, an azo complex dye, a naphthene acid metal salt, a metal complex or metal salt (the metal is a chrome, a zinc, a zirconium or the like) of a salicylic acid or of a derivative thereof, a boron compound, a fatty acid soap, a long-chain alkylcarboxylic acid salt and a resin acid soap. The charge control agents may be used each alone, or optionally two or more of them may be used in combination. Although the amount of the charge control agent to be used is not particularly limited and can be properly selected from a wide range, 0.5 part by weight or more and 3 parts by weight or less is preferably used based on 100 parts by weight of the binder resin.

Further, the toner base particles may contain a release agent in addition to the binder resin and the colorant. As the release agent, it is possible to use ingredients which are customarily used in the relevant field, including, for example, petroleum wax such as paraffin wax and derivatives thereof, and microcrystalline wax and derivatives thereof; hydrocarbon-based synthetic wax such as Fischer-Tropsch wax and derivatives thereof, polyolefin wax (e.g. polyethylene wax and polypropylene wax) and derivatives thereof, low-molecular-weight polypropylene wax and derivatives thereof, and polyolefinic polymer wax (low-molecular-weight polyethylene wax, etc.) and derivatives thereof; vegetable wax such as carnauba wax and derivatives thereof, rice wax and derivatives thereof, candelilla wax and derivatives thereof, and haze wax; animal wax such as bees wax and spermaceti wax; fat and oil-based synthetic wax such as fatty acid amides and phenolic fatty acid esters; long-chain carboxylic acids and derivatives thereof; long-chain alcohols and derivatives thereof; silicone polymers; and higher fatty acids. Note that examples of the derivatives include oxides, block copolymers of a vinylic monomer and wax, and graft-modified derivatives of a vinylic monomer and wax. A usage of the wax may be appropriately selected from a wide range without particularly limitation, and preferably 0.2 part by weight to 20 parts by weight, more preferably 0.5 part by weight to 10 parts by weight, and particularly preferably 1.0 part by weight to 8.0 parts by weight based on 100 parts by weight of the binder resin.

The toner base particles obtained at the toner base particle producing step S1 preferably have a volume average particle size of 4 μm or more and 8 μm or less. In a case where the volume average particle size of the toner base particles is 4 μm or more and 8 μm or less, it is possible to stably form a high-definition image for a long time. Moreover, by reducing the particle size to this range, a high image density is obtained even with a small amount of adhesion, which generates an effect capable of reducing an amount of toner consumption. In a case where the volume average particle size of the toner base particles is less than 4 μm, the particle size of the toner base particles becomes too small and high charging and low fluidity are likely to occur. When the high charging and the low fluidity occur, a toner is unable to be stably supplied to a photoreceptor and a background fog and image density decrease are likely to occur. In a case where the volume average particle size of the toner base particles exceeds 8 μm, the particle size of the toner base particles becomes large and the layer thickness of a formed image is increased so that an image with remarkable granularity is generated and the high-definition image is not obtainable, which is undesirable. In addition, as the particle size of the toner base particles is increased, a specific surface area is reduced, resulting in decrease in a charge amount of the toner. When the charge amount of the toner is reduced, the toner is not stably supplied to the photoreceptor and pollution inside the apparatus due to toner scattering is likely to occur.

(2) Fine Resin Particle Preparing Step S2

At the fine resin particle preparing step S2, dried fine resin particles are prepared. Any methods may be used for the drying and it is possible to obtain the dried fine resin particles by a method such as drying with hot air receiving type, drying with heat transfer by heat conduction type, far infrared radiation drying, and microwave drying. The fine resin particles are used as a shell agent coating the toner base particle at the subsequent coating step S3. By coating the toner base particle, for example, it is possible to prevent generation of toner aggregation during storage due to melting of low-melting point components such as a release agent contained in the toner base particles. Further, for example, in a case where a liquid in which the fine resin particles are dispersed is sprayed to coat the toner base particles, the shape of the fine resin particles remains on the surface of the toner base particle, and therefore, it is possible to obtain toner particles excellent in cleaning property compared to toner particles with smooth surfaces.

The fine resin particles can be obtained, for example, in a manner that resin which is a raw material of the fine resin particles is emulsified and dispersed into fine grains by using a homogenizer or the like machine. Further, the fine resin particles can also be obtained by polymerizing monomer components of the resin.

As the raw material of the fine resin particles, resin used for materials of a toner is usable and examples thereof include polyester, acrylic resin, styrene resin, and styrene-acrylic copolymer.

The resins used as a raw material of the fine resin particle are able to be classified into an amorphous resin or a crystalline resin based on the difference in the arrangement states of polymer.

The amorphous resin is a resin in which polymer is in an amorphous state, crystallinity is low, and a crystalline index is less than 0.6, or the crystalline index exceeds 1.5. The crystalline resin is a resin in which polymer has a regular molecule structure, a rate of a crystalline part (degree of crystallinity) in the resin is large, and the crystalline index is 0.6 to 1.5.

The crystalline index is a value defined by a ratio of a softening temperature of a resin to an endothermic maximum peak temperature (softening temperature/endothermic maximum peak temperature), and serves as an indicator of the crystallinity. The endothermic maximum peak temperature indicates a peak temperature on the side of the highest temperature of the endothermic peak to be observed. The endothermic maximum peak temperature is regarded as a melting point when a difference from the softening temperature is within 20° C., and regarded as being caused by the glass transition in the case of the difference from the softening temperature exceeding 20° C.

The degree of crystallinity is able to be adjusted according to the type of a raw material monomer and a rate thereof, and manufacturing conditions (such as a reaction temperature, a reaction time, a cooling speed, and the like).

In the method of manufacturing a capsule toner according to the invention, as the fine resin particle, an amorphous fine resin particle and a crystalline fine resin particle are prepared.

<Amorphous Fine Resin Particle>

Examples of an amorphous resin include a styrene resin such as a polystyrene resin, an acrylic resin such as a styrene-acrylic copolymer resin, polymethylmethacrylate, a polyolefin resin such as polyethylene, polyester, polyurethane, and an epoxy resin.

With the composition of the monomers, the styrene-acrylic copolymer resin is capable of controlling the hydrophobic property thereof, and therefore it is possible to suppress deterioration in charging under the high temperature and high humidity environment. Further, since the polymerization degree and the compounding ratio are selectable, the degree of freedom of a thermal design thereof is high, and it is possible to be used as a toner material suitably.

As the acrylic monomer of the styrene-acrylic copolymer resin, one heretofore known can be used, and examples thereof include acrylic acid, methacrylic acid, acrylic acid ester, and methacrylic acid ester, which may have a substituent. Specific examples of the acrylic monomer include monomers of acrylic esters such as methyl acrylate, ethyl acrylate, isopropyl acrylate, n-butyl acrylate, isobutyl acrylate, n-amyl acrylate, isoamyl acrylate, n-hexyl acrylate, 2-ethylhexyl acrylate, n-octyl acrylate, decyl acrylate, and dodecyl acrylate; monomers of methacrylic esters such as methyl methacrylate, propyl methacrylate, n-butyl methacrylate, isobutyl methacrylate, n-amyl methacrylate, n-hexyl methacrylate, 2-ethylhexyl methacrylate, n-octyl methacrylate, decyl methacrylate, and dodecyl methacrylate; and hydroxyl group-containing monomers of (meth)acrylic esters such as hydroxyethyl acrylate and hydroxypropyl methacrylate. The acrylic monomer may be used each alone, or two or more of the acrylic monomers may be used in combination.

As the styrene monomer of the styrene-acrylic copolymer resin, one heretofore known can be used, and examples thereof include styrene and α-methyl styrene. The styrene monomers may be used each alone, or two or more of them may be used in combination. The polymerization of these monomers is performed by using a common radical initiator by solution polymerization, suspension polymerization, emulsification polymerization, or the like.

Polyester resin has a high refractive index and is excellent in optical characteristics, and therefore is excellent as a binder of a colorant such as a pigment, and furthermore, since the degree of freedom of a thermal design is high, the melting characteristics at a further lower temperature is controllable, and therefore, is able to be used suitably for the low temperature fixation toner, particularly.

“Amorphous polyester” refers to polyester whose crystalline index is more than 1.5, or less than 0.6, and preferably the polyester whose crystalline index is more than 1.5.

The amorphous polyester is obtained through condensation polymerization of an alcohol component containing 60 mol % or more of aliphatic diol whose number of carbon is 3 to 10, and a carboxylic acid component containing 80 mol % or more of an aromatic dicarboxylic acid compound and containing 1 to 50 mol % of a polycyclic aromatic dicarboxylic acid compound whose number of carbon is 12 or more as the aromatic dicarboxylic acid compound. Preferably, it is obtained through condensation polymerization of an alcohol component containing 80 mol % or more of aliphatic dial whose number of carbon is 4 to 10, and a carboxylic acid component containing 80 mol % more of an aromatic dicarboxylic acid compound and containing 1 to 50 mol % of a polycyclic aromatic dicarboxylic acid compound whose number of carbon is 12 or more as the aromatic dicarboxylic acid compound.

As the aliphatic diol whose number of carbon is 3 to 10, linear aliphatic diol whose number of carbon is 4 to 10 and branched-chain aliphatic diol whose number of carbon is 3 to 10 are preferable. Further, by containing polyester whose crystallinity is high as a binder resin, which is obtained with an alcohol component containing the linear aliphatic diol as a main component and further containing the branched-chain aliphatic diol, and a carboxylic acid component containing an aromatic carboxylic acid compound as raw material monomers, the low temperature fixation property is able to be improved further. Note that, the branched-chain aliphatic diol refers to dial such that an alkylene group in which 2 of OH groups are bonded has branches or diol having a secondary OH group.

Examples of the linear aliphatic diol whose number of carbon is 4 to 10 include 1,4-butanediol, 1,5-pentanediol, 1,6-hexanediol, 1,7-neptanediol, 1,8-octanediol, 1,9-nonanediol, 1,10-decanediol, and 1,4-butenediol, and from a view point of accelerating crystallinity, α,ω-linear alkane dial is preferable, and 1,4-butanediol, 1,6-hexanediol, 1,8-octanediol, and 1,10-decanediol are further preferable. A content of the linear aliphatic diol whose number of carbon is 4 to 10 is preferably 50 to 90 mol % in the alcohol component, and from the view point of accelerating the crystallinity, 60 to 90 mol % is further preferable.

Examples of the branched-chain aliphatic diol whose number of carbon is 3 to 10 include 1,2-propanediol, 1,3-butanediol, neopentyl glycol, and 2-butyl-2-ethyl-1,3-propanediol. A content of the branched-chain aliphatic diol whose number of carbon is 3 to 10 is preferably 10 to 50 mol % in the alcohol component, and from the view point of accelerating the low temperature fixation property, 10 to 40 mol % is further preferable.

A molar ratio of the linear aliphatic diol whose number of carbon is 4 to 10 to the branched-chain aliphatic diol whose number of carbon is 3 to 10 (linear aliphatic diol whose number of carbon is 4 to 10/branched-chain aliphatic diol whose number of carbon is 3 to 10) is, from the view point of the low temperature fixation property, preferably 60/40 to 90/10, and more preferably, 70/30 to 85/15, and further more preferably, 70/30 to 80/20.

A content of the aliphatic diol whose number of carbon is 3 to 10 is 60 mol % or more, preferably 80 mol % or more in the alcohol component, and from the view point of accelerating the crystallinity, 85 mol % or more is more preferable.

In the alcohol component, an alcohol other than the aliphatic diol whose number of carbon is 3 to 10 may be contained within a range of not harming the effects of the invention. Examples of such an alcohol component include aliphatic diol other than that whose number of carbon is 3 to 10 such as ethylene glycol; aromatic diols such as alkylene oxide adducts of bisphenol A represented by polyoxypropylene(2.2)-2,2-bis(4-hydroxyphenyl)propane, polyoxyethylene(2.2)-2,2-bis(4-hydroxyphenyl)propane; alicyclic diol such as 1,4-cyclohexanedimethanol; and trivalent or more polyhydric alcohol such as glycerin, pentaerythritol.

As the aromatic dicarboxylic acid compound, a compound having a benzene skeleton such as phthalic acid, isophthalic acid, terephthalic acid, acid anhydrides thereof, and derivatives such as an alkyl (number of carbon: 1 to 3) ester are preferable. A content of the aromatic dicarboxylic acid compound is, in the carboxylic acid component, 80 mol % or more, and from the view point of the low temperature fixation property, durability, and charging stability under the high temperature and high humidity environment, 85 mol % or more is preferable.

As the polycyclic aromatic dicarboxylic acid compound whose number of carbon is 12 or more, a compound having a benzene skeleton such as 2,6-naphthalenedicarboxylic acid, 1,5-naphthalenedicarboxylic acid, 2,7-naphthalenedicarboxylic acid, 1,4-naphthalenedicarboxylic acid, 4,4-biphenyldicarboxylic acid, acid anhydrides thereof, and derivatives such as an alkyl (number of carbon: 1 to 3) ester are preferable, and as the number of carbons, 12 to 30 are preferable, and 12 to 24 are more preferable. Among them, from the view point of the crystallinity of the polyester, 2,6-naphthalenedicarboxylic acid, and 1,5-naphthalenedicarboxylic acid are preferable. A content of the polycyclic aromatic dicarboxylic acid compound whose number of carbon is 12 or more, in the carboxylic acid component, 1 to 50 mol %, and from the view point of the crystallinity of the polyester and the low temperature fixation property of the toner, 5 to 40 mol % is preferable, and 10 to 30 mol % is more preferable.

A total content of the aromatic dicarboxylic acid compound and the polycyclic aromatic dicarboxylic acid compound described above is, in the carboxylic acid component, 80 mol % or more, and from the view point of the low temperature fixation property, the durability and the charging stability under the high temperature and high humidity conditions, 85 mol % or more is preferable, and 90 to 100 mol % is more preferable.

Examples of the carboxylic acid component other than the above-described aromatic dicarboxylic acid compound include the aliphatic dicarboxylic acid such as oxalic acid, malonic acid, maleic acid, fumaric acid, citraconic acid, itaconic acid, glutaconic acid, succinic acid, adipic acid, sebacic acid, azelaic acid, n-dodecyl succinic acid, or n-dodecenyl succinic acid, the alicyclic dicarbocyclic acid such as a cyclohexanedicarboxylic acid; trivalent or more polyhydric carboxylic acid such as trimellitic acid and pyromellitic acid, and acid anhydrides thereof, derivatives such as an alkyl (number of carbon: 1 to 3) ester.

<Crystalline Fine Resin Particle>

Examples of the crystalline resin include crystalline polyester, and crystalline polyethylene, crystalline polypropylene, in which the crystallinity of the above-described resin is enhanced.

The polyester in the crystalline resin is obtained through condensation polymerization of an alcohol component containing 60 mol % or more of aliphatic diol whose number of carbon is 3 to 10, and a carboxylic acid component containing 80 mol % or more of an aromatic dicarboxylic acid compound. The one obtained through condensation polymerization of an alcohol component containing 80 mold or more of aliphatic diol whose number of carbon is 4 to 10, and a carboxylic acid component containing 80 mol % or more of an aromatic dicarboxylic acid compound, is preferable.

Examples of the alcohol component include the same as those of the above-described amorphous polyester.

As the aromatic dicarboxylic acid compounds, a compound having a benzene skeleton such as phthalic acid, isophthalic acid, terephthalic acid, acid anhydrides thereof, and derivatives such as an alkyl (number of carbon: 1 to 3) ester are preferable, and among them, from the view point accelerating the crystallinity, terephthalic acid and its derivatives are more preferable.

A content of the aromatic dicarboxylic acid compound is, in the carboxylic acid component, 80 mol % or more, and from the view point of the low temperature fixation property, the durability and the charging stability under the high temperature and high humidity conditions, 80 mol % or more is preferable.

Examples of the carboxylic acid component other than the above-described aromatic dicarboxylic acid compound include the aliphatic dicarboxylic acid such as oxalic acid, malonic acid, maleic acid, fumaric acid, citraconic acid, itaconic acid, glutaconic acid, succinic acid, adipic acid, sebacic acid, azelaic acid, n-dodecyl succinic acid, or n-dodecenyl succinic acid; alicyclic dicarbocyclic acid such as cyclohexanedicarboxylic acid; trivalent or more polyhydric carboxylic acid such as trimellitic acid, pyromellitic acid, and acid anhydrides thereof; and derivatives such as alkyl (number of carbon: 1 to 3) ester. Among them, from the view point of accelerating the crystallinity, the aliphatic dicarboxylic acid compound is preferable, particularly, fumaric acid compound and the fumaric acid are preferable.

A molar ratio of the alcohol component to the carboxylic acid component (alcohol component/carboxylic acid component) in either of the embodiment of the amorphous polyester and the embodiment of the crystalline polyester, from the view point of the fixation property to paper and the charging stability, 100/70 to 100/120 are preferable.

The crystalline polyester resin and the other polyester resin used for the toner of the invention is compounded by a polyhydric carboxylic acid component and a polyhydric alcohol component.

<Crystalline Polyester Fine Resin Particle>

A crystalline polyester resin refers to a polyester resin whose crystalline index is 0.6 to 1.5, preferably, 0.8 to 1.2. The crystalline polyester resin is able to be manufactured by a heretofore known method disclosed in Japanese Unexamined Patent Publication JP-A 2006-113473, for example, and obtained through condensation polymerization of an alcohol component and a carboxylic acid component which are raw material monomers.

As the alcohol component, it is preferable to include a compound which enhances the crystallinity of a resin such as aliphatic diol whose number of carbon is 2 to 8.

Examples of the aliphatic diol whose number of carbon is 2 to 8 include ethylene glycol, 1,2-propylene glycol, 1,3-propylene glycol, 1,4-butanediol, 1,5-pentanediol, 1,6-hexanediol, 1,7-heptanediol, 1,8-octanediol, neopentyl glycol, and 1,4-butenediol, and particularly, α,ω-linear alkane diol is preferable.

A content of the aliphatic diol whose number of carbon is 2 to 8 in the alcohol component is, from the view point of the crystallinity, preferably 80 mol % or more. Further, among them, 70 mol % or more is preferable to be occupied by one type of aliphatic diol.

Examples of the carboxylic acid component include carboxylic acid and its derivatives such as carboxylic anhydride and carboxylic acid ester, and among them, the carboxylic acid is preferable.

Examples of the carboxylic acid include aliphatic dicarboxylic acid whose number of carbon is 2 to 30 such as fumaric acid, adipic acid, oxalic acid, malonic acid, maleic acid, citraconic acid, itaconic acid, glutaconic acid, succinic acid, sebacic acid, azelaic acid, n-dodecyl succinic acid, or n-dodecenyl succinic acid; aromatic dicarboxylic acid such as phthalic acid, isophthalic acid, or terephthalic acid; alicyclic dicarboxylic acid such as cyclohexanedicarboxylic acid; and trivalent or more polyhydric carboxylic acid such as trimellitic acid or pyromellitic acid. Among them, from the view point of the crystallinity, the aliphatic dicarboxylic acid is preferable, and the aliphatic dicarboxylic acid whose number of carbon is 2 to 8 is more preferable. The content of the aliphatic dicarboxylic acid compound in the carboxylic acid component is preferably 70 mol % or more.

As a molar ratio of the alcohol component and the carboxylic acid component in the crystalline polyester resin is, when the molecular weight of the crystalline polyester resin is increased, it is preferable that an amount of the alcohol component is more than that of the carboxylic acid component, and at the time of reaction of depressurizing, the molar ratio (carboxylic acid component/alcohol component) of 0.9 or more and less than 1 is preferable, since the molecular weight of the polyester is easily adjustable by distilling away the alcohol component.

In producing the crystalline polyester resin, the condensation polymerization of the alcohol component and the carboxylic acid component is able to be performed at the temperature of 120 to 230° C. by using, for example, an esterification catalyst, when necessary, in an inert gas atmosphere.

The softening temperature of the resin used as the raw material of the fine resin particle is preferably higher than the glass transition temperature of the binder resin contained in the toner base particle, and mare preferably 50° C. or higher. Particularly, the softening temperature of the crystalline polyester resin is, from the view point of the low temperature fixation property, preferably 70 to 140° C. By using the resin in such a temperature range, a toner provided with both the preservation stability and the fixation property is able to be obtained.

The volume average particle size of the fine resin particles needs to be sufficiently smaller than the average particle size of the toner base particles, and is preferably 0.05 μm or more and 1 μm or less. More preferably, the volume average particle size of the fine resin particles is 0.1 μm or more and 0.5 μm or less. In a case where the volume average particle size of the fine resin particles is 0.05 μm or more and 1 μm or less, projection with a suitable size is formed on the surface of the toner base particle. Whereby, the toner manufactured with the method of the invention is easily caught by cleaning blades at the time of cleaning, resulting in improvement of the cleaning property.

Further, it is preferable that a volume median particle size of the crystalline polyester fine resin particles is smaller than a volume median particle size of the amorphous fine resin particles. For example, the volume median particle size of the crystalline polyester fine resin particles is preferably 50% to 100% relative to the volume median particle size of the amorphous fine resin particles. When the volume median particle size of the crystalline polyester fine resin particles is less than 50% relative to the volume median particle size of the amorphous fine resin particles, handling of the crystalline polyester fine resin particle becomes difficult and thus a problem that suitable coating of the toner base particle becomes impossible occurs, and when exceeding 100%, a problem that the blocking resistance of the toner is harmed with the crystalline resin occurs.

It is preferable that an addition amount of the fine resin particles are 3 parts by weight or more based on 100 parts by weight of the toner base particles. In case of less than 3 parts by weight, it is so difficult to uniformly coat the toner base particle that depending on a type of the toner base particles the preservation stability may degrade.

(3) Coating Step S3

A coating step S3 includes a mixed fine resin particle adhering step S3a, a temperature regulation step S3b, a spraying step S3c, a film-forming step S3d, and a collecting step S3e.

(3-1) Mixed Fine Resin Particle Adhering Step S3a

At the mixed fine resin particle adhering step S3a, first, the amorphous fine resin particles and the crystalline polyester fine resin particles produced at the fine resin particle preparing step S2 are mixed by a mixer such as a Henschel mixer to obtain mixed fine resin particles.

A content of the crystalline polyester in the mixed fine resin particles is preferably 20% by weight or more and 50% by weight or less. When a content of the crystalline polyester in the mixed fine resin particles is less than 20% by weight, the effect of melting the resin coating layer is not sufficient so that the low temperature fixation property is hampered. When the content of the crystalline polyester exceeds 50% by weight, the effect of the heating resistance with the amorphous resin is not able to be utilized, thus improvement of the blocking resistance becomes difficult.

Since the crystalline resin particles exist between the amorphous resin particles uniformly in the mixed fine resin particles, when the resin coating layer is formed, the effects of these resins are exerted.

Next, the mixed fine resin particles and the toner base particles produced at the toner base particle producing step S1 are mixed by a mixer such as the Henschel mixer to obtain base particles having fine resin particles adhered thereto in which on the surfaces of the toner base particles the mixed fine resin particles are adhered.

Usable mixers include heretofore known mixers including, for example, a Henschel-type mixing apparatus such as HENSCHEL MIXER (trade name, manufactured by Mitsui Mining Co., Ltd.), SUPERMIXER (trade name, manufactured by Kawata MFG Co., Ltd.), and MECHANOMILL (trade name, manufactured by Okada Seiko Co., Ltd.)

<Toner Manufacturing Apparatus>

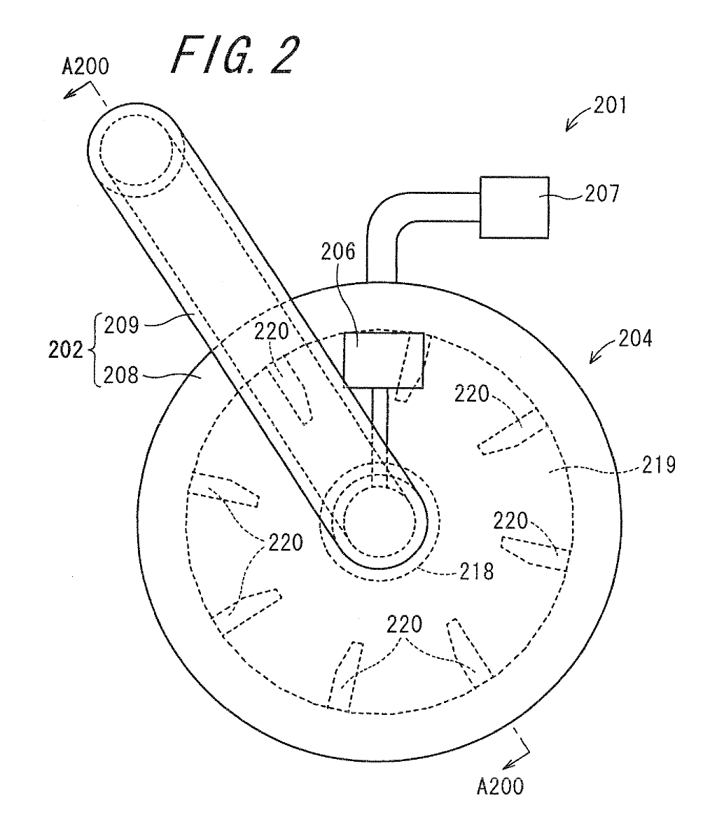

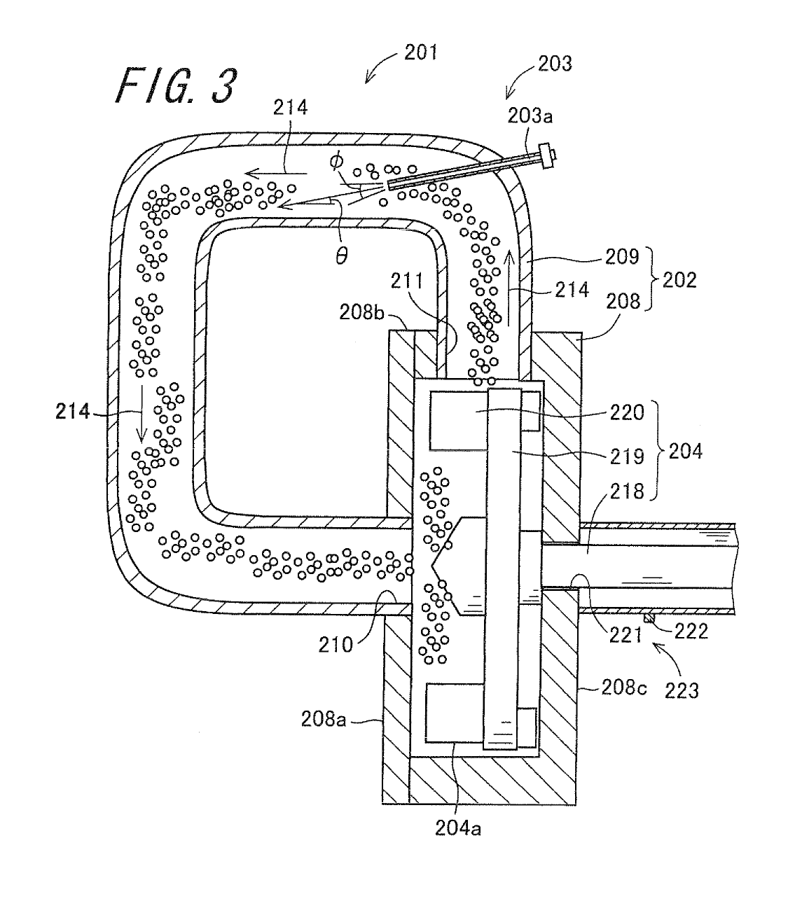

FIG. 2 is a front view showing a configuration of a toner manufacturing apparatus 201 for using in an example of the method of manufacturing a capsule toner according to the invention. FIG. 3 is a schematic sectional view of the toner manufacturing apparatus 201 shown in FIG. 2 taken along a sectional line A200-A200. At the coating step S3, by using the toner manufacturing apparatus 201 shown in FIG. 2, for example, the resin coating layer is formed on the surface of the toner base particle with an impact force by a multiplier effect of circulation and stirring inside the apparatus. The toner manufacturing apparatus 2C1 is a rotary stirring apparatus including a powder passage 202, a spraying section 203, a rotary stirring section 204, a temperature regulation jacket (not shown), a powder inputting section 206, and a powder collecting section 207. The rotary stirring section 204 and the powder passage 202 constitute a circulating section.

(Powder Passage)

The powder passage 202 is comprised of a stirring section 208 and a powder flowing section 209. The stirring section 208 is a cylindrical container-like member having an internal space. Opening sections 210 and 211 are formed in the stirring section 208 which is a rotary stirring chamber. The opening section 210 is formed at an approximate center part of a surface 208a in one side of the axial direction of the stirring section 208 so as to penetrate a side wall including the surface 208a of the stirring section 208 in the thickness direction. Moreover, the opening section 211 is formed at a side surface 208b perpendicular to the surface 208a in one side of the axial direction of the stirring section 208 so as to penetrate a side wall including the side surface 208b of the stirring section 208 in the thickness direction. The powder flowing section 209 which is a circulation tube has one end connected to the opening section 210 and the other end connected to the opening section 211. Whereby, the internal space of the stirring section 208 and the internal space of the powder flowing section 209 are communicated to form the powder passage 202. The base particles having fine resin particles adhered thereto and gas flow through the powder passage 202. The powder passage 202 is provided so that the powder flowing direction which is a direction in which the base particles having fine resin particles adhered thereto flow is constant.

The temperature in the powder passage 202 is set to a glass transition temperature of the toner base particle or less, and is more preferably 30° C. or higher and not more than a glass transition temperature of the toner base particle. The temperature in the powder passage 202 is almost uniform at any parts by the flow of the toner base particles. In a case where the temperature in the powder passage 202 exceeds the glass transition temperature of the toner base particle, there is a possibility that the toner base particles are softened excessively and aggregation of the toner base particles is generated. Further, in a case where the temperature is lower than 30° C., the drying speed of the dispersion liquid is made slow and the productivity is lowered. Accordingly, in order to prevent aggregation of the toner base particles, it is necessary to maintain the temperatures of the powder passage 202 and the after-mentioned rotary stirring section 204 to the glass transition temperature of the toner base particle or less. Therefore, the after-mentioned temperature regulation jacket whose inner diameter is larger than the external diameter of the powder passage tube is disposed at least on a part of the outer side of the powder passage 202 and the rotary stirring section 204.

(Rotary Stirring Section)

The rotary stirring section 204 includes a rotary shaft member 218, a discotic rotary disc 219, and a plurality of stirring blades 220. The rotary shaft member 218 is a cylindrical-bar-shaped member that has an axis matching an axis of the stirring section 208, that is provided so as to be inserted in a through-hole 221 formed at the surface 208c in the other side of the axial direction of the stirring section 208 to penetrate the side wall including the surface 208c in the thickness direction, and that is rotated around the axis by a motor (not shown). The rotary disc 219 is a discotic member having the axis supported by the rotary shaft member 218 so as to match the axis of the rotary shaft member 218 and rotating with rotation of the rotary shaft member 218. The plurality of stirring blades 220 are supported by the peripheral edge of the rotary disc 219 and are rotated with rotation of the rotary disc 219.

At the coating step S3, the peripheral speed of the outermost periphery of the rotary stirring section 204 is preferably set to 30 m/sec or more, and more preferably to 50 m/sec or more. The outermost periphery of the rotary stirring section 204 is a part 204a of the rotary stirring section 204 that has the longest distance from the axis of the rotary shaft member 218 in the direction perpendicular to the extending direction of the rotary shaft member 218 of the rotary stirring section 204. In a case where the peripheral speed in the outermost periphery of the rotary stirring section 204 is set to 30 m/sec or more at the time of rotation, it is possible to isolate and fluidize the base particles having fine resin particles adhered thereto. In a case where the peripheral speed in the outermost periphery is less than 30 m/sec, it is impossible to isolate and fluidize the base particle having fine resin particles adhered thereto thus making it impossible to uniformly coat the toner base particles with the resin film.

The base particles having fine resin particles adhered thereto preferably collide with the rotary disc 219 vertically. Whereby, it is possible to stir the base particles having fine resin particles adhered thereto sufficiently, to coat the toner base particles with the mixed fine resin particles more uniformly and to further improve yield of the toner in which the coating layer is uniform.

(Spraying Section)

The spraying section 203 is provided so as to be inserted in an opening formed on an outer wall of the powder passage 202, and in the powder flowing section 209, the spraying section 203 is provided in the powder flowing section that is on the side closest to the opening section 211 in the flowing direction of the base particles having fine resin particles adhered thereto. The spraying section 203 includes a liquid reservoir that reserves liquid, a carrier gas supplying section that supplies carrier gas, and a two-fluid nozzle that mixes the liquid and the carrier gas, and ejects the resultant mixture to the toner base particles present in the powder passage 202 so as to spray droplets of the liquid to the toner base particles. As the carrier gas, compressed air or the like is usable. The liquid fed to the spraying section 203 by a liquid feeding pump with a constant volume of flow and then sprayed by the spraying section 203 is gasified so that the gasified liquid is spread on the surfaces of the toner base particles and the mixed fine resin particles. Whereby, the toner base particles and the mixed fine resin particles are plasticized.

(Temperature Regulation Jacket)

The temperature regulation jacket (not shown), which is a temperature regulation section, is provided at least on a part of the outside of the powder passage 202 and regulates temperatures in the powder passage 202 and of the rotary stirring section 204 to a predetermined temperature by passing a cooling medium or a heating medium through the internal space of the jacket. This makes it possible at a temperature regulation step S3a mentioned below to control the temperature in the powder passage and outside of the rotary stirring section to a temperature or less at which the toner base particles and the mixed fine resin particles are not softened and deformed. Moreover, at a spraying step S3c and a film-forming step S3d, a variation in the temperatures applied to the toner base particles, the mixed fine resin particles and the liquid can be reduced, and thus the stable fluidizing state of the base particles having fine resin particles adhered thereto can be kept.

In the embodiment, the temperature regulation jacket is preferably provided over the entire outside of the powder passage 202. The base particles having fine resin particles adhered thereto generally collide with the inner wall of the powder passage many times, and a part of the collision energy is converted into the thermal energy at the time of collision and is accumulated in the toner base particles and the mixed fine resin particles. As the number of the collision increases, the thermal energy accumulated in the particles increases and then the toner base particles and the mixed fine resin particles are softened to adhere to the inner wall of the powder passage. By providing the temperature regulation jacket over the entire outside of the powder passage 202, an adhesive force of the toner base particles and the mixed fine resin particles to the inner wall of the powder passage is lowered so that it is possible to reliably prevent adhesion of the toner base particles to the inner wall of the powder passage 202 due to a rapid temperature rise in the apparatus and thus to avoid the narrowing inside the powder passage due to the toner base particles and the mixed fine resin particles. Accordingly, the toner base particles are coated with the mixed fine resin particles uniformly, resulting that it is possible to manufacture a toner excellent in cleaning property in higher yield.

Further, inside the powder flowing section 209 in the downstream of the spraying section 203, the sprayed liquid is in the state of remaining without being dried, and the drying speed becomes slow when the temperature is not appropriate so that the liquid easily accumulates. When the toner base particle contacts thereto, the toner base particle easily adheres to the inner wail of the powder flowing passage 202 and thus becomes a source of occurrence of toner aggregation. On the inner wall near the opening section 210, the base particles having fine resin particles adhered thereto flowed into the stirring section 208 collide with the base particles having fine resin particles adhered thereto flowing inside the stirring section 208 by stirring with the rotary stirring section 204, so that the collided toner base particles easily adhere to the vicinity of the opening section 210. Therefore, by providing a temperature regulation jacket on such a part that the toner base particles easily adhere, the adhesion of the toner base particles to the inner wall of the powder passage 202 is able to prevented more reliably.

(Powder Inputting Section and Powder Collecting Section)

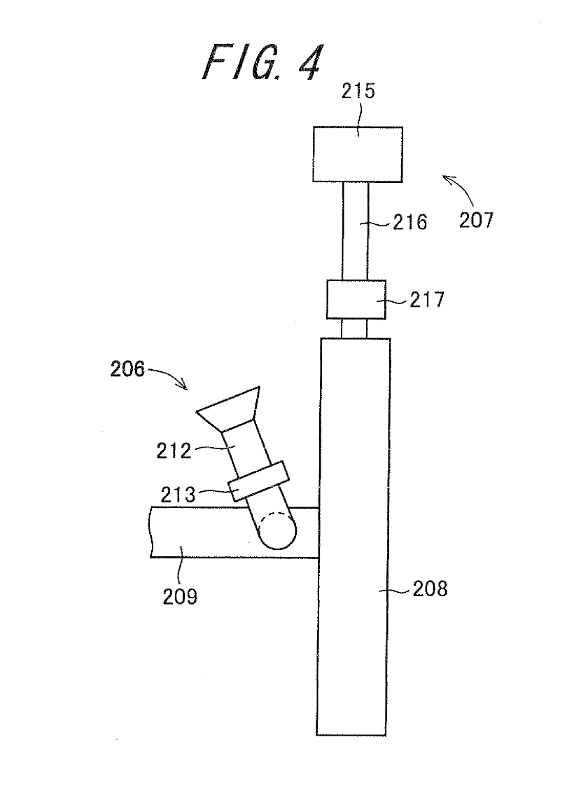

The powder inputting section 206 and the powder collecting section 207 are connected to the powder flowing section 209 of the powder passage 202. FIG. 4 is a front view showing a configuration around the powder inputting section 206 and the powder collecting section 207.

The powder inputting section 206 includes a hopper (not shown) that supplies the base particles having fine resin particles adhered thereto, a supplying tube 212 that communicates the hopper and the powder passage 202, and an electromagnetic valve 213 provided in the supplying tube 212. The base particles having fine resin particles adhered thereto supplied from the hopper are supplied to the powder passage 202 through the supplying tube 212 in a state where the passage in the supplying tube 212 is opened by the electromagnetic valve 213. The base particles having fine resin particles adhered thereto supplied to the powder passage 202 flow in the constant powder flowing direction with stirring by the rotary stirring section 204. Moreover, the base particles having fine resin particles adhered thereto are not supplied to the powder passage 202 in a state where the passage in the supplying tube 212 is closed by the electromagnetic valve 213.

The powder collecting section 207 includes a collecting tank 215, a collecting tube 216 that communicates the collecting tank 215 and the powder passage 202, and an electromagnetic valve 217 provided in the collecting tube 216. The toner particles flowing through the powder passage 202 are collected in the collecting tank 215 through the collecting tube 216 in a state where the passage in the collecting tube 216 is opened by the electromagnetic valve 217. Moreover, the toner particles flowing through the powder passage 202 are not collected in a state where the passage in the collecting tube 216 is closed by the electromagnetic valve

(3-2) Temperature Regulation Step S3a

At the temperature regulation step S3a, while the rotary stirring section 204 is rotated, temperatures in the powder passage 202 and of the rotary stirring section 204 are regulated to a predetermined temperature by passing a medium through the temperature regulation jacket disposed on the outside thereof. This makes it possible to control the temperature in the powder passage 202 at a temperature or less at which the base particles having fine resin particles adhered thereto that are inputted at the after-mentioned spraying step S3c are not softened and deformed.

(3-3) Spraying Step S3c

At the spraying step S3c, to the base particles having fine resin particles adhered thereto in the fluidized state, a liquid having an effect of plasticizing the particles without dissolving particles thereof is sprayed from the above-described spraying section 203 with carrier gas.

The base particles having fine resin particles adhered thereto are supplied to the powder passage 202 from the powder inputting section 206 in a state where a rotary shaft member 218 of the rotary stirring section 204 is rotating. The base particles having fine resin particles adhered thereto supplied to the powder passage 202 are stirred by the rotary stirring section 204 in the powder flowing section 209 of the powder passage 202 into a direction of an arrow 214.

The sprayed liquid is gasified so that the inside of the powder passage 202 becomes a constant gas concentration, and the gasified liquid is preferably exhausted to the outside of the powder passage through a through hole 221. Thereby, the concentration of the gasified liquid inside the powder passage 202 is able to be maintained constant, and the drying speed of the liquid is able to be accelerated compared to the case of not maintaining the concentration constant. Therefore, it is possible to prevent the toner particles in which the undried liquid remains from adhering to the other toner particles, suppress aggregation of the toner particles, and improve the yield of the toner particle whose coating layer is uniform.

The concentration of the gasified liquid measured by a concentration sensor at the gas exhausting section 222 is preferably approximately 3% or less. When the concentration is approximately 3% or less, the drying speed of the liquid is able to be accelerated sufficiently, so that it is possible to prevent the toner particles in which undried liquid remains from adhering to the other toner particles and to prevent aggregation of the toner particles. Furthermore, the concentration of the gasified liquid is further preferably 0.1% or more and 3.0% or less. In the case where the spraying speed is within such a range, the aggregation of the toner particles is able to be prevented without lowering the productivity.

In the embodiment, it is preferable to start spraying after stabilizing the flowing speed of the base particles having fine resin particles adhered thereto in the powder passage 202. Thereby the liquid is able to be sprayed to the base particles having fine resin particles adhered thereto uniformly, and the yield of the toner whose coating layer is uniform is able to be improved.

The liquid having an effect of plasticizing the toner base particles and the mixed fine resin particles without dissolving is not particularly limited, but is preferably a liquid that is easily vaporized since the liquid needs to be removed from the toner base particles and the mixed fine resin particles after the liquid is sprayed. Examples of such a liquid include a liquid containing lower alcohol. Examples of the lower alcohol include methanol, ethanol, and propanol. In a case where the liquid contains such lower alcohol, it is possible to enhance wettability of the mixed fine resin particles as a coating material with respect to the toner base particles and adhesion, deformation and film-forming of the mixed fine resin particles are easily performed over the entire surface or a large part of the toner base particles. Further, since the lower alcohol has a high vapor pressure, it is possible to further shorten the drying time at the time of removing the liquid and to suppress aggregation of the toner base particles.

Further, the viscosity of the liquid is preferably 5 cP or less. The viscosity of the liquid is measured at 25° C. The viscosity of the liquid can be measured, for example, by a cone/plate type rotation viscometer. A preferable example of the liquid having the viscosity of 5 cP or less includes alcohol. Examples of the alcohol include methyl alcohol and ethyl alcohol. These alcohols have the low viscosity and are easily vaporized, and therefore, when the liquid contains the alcohol, it is possible to spray the liquid with a minute droplet diameter without coarsening a diameter of the spray droplet of the liquid to be sprayed from the spraying section 203. It is also possible to spray the liquid with a uniform droplet diameter. It is possible to further promote fining of the droplet at the time of collision of the toner base particles and the droplet. This makes it possible to obtain a coated toner having excellent uniformity by uniformly wetting the surfaces of the toner base particles and the mixed fine resin particles with the liquid and applying the liquid to the surfaces of the toner base particles and the mixed fine resin particles and softening the mixed fine resin particles by a multiplier effect with collision energy.

An angle θ formed by the liquid spraying direction which is a direction of the axis of the two-fluid nozzle of the spraying section 203 and the powder flowing direction which is a direction in which the base particles having fine resin particles adhered thereto flow in the powder passage 202 is preferably 0° or more and 45° or less. In a case where the angle θ falls within this range, the droplets of the liquid are prevented from recoiling from the inner wall of the powder passage 202, and yield of the toner base particle coated with the resin film can be further improved. In a case where the angle exceeds 45°, the droplets of the liquid easily recoil from the inner wall of the powder passage 202 and the liquid is easily retained, thus generating aggregation of the toner particles and deteriorating the yield.

Further, a spreading angle of the liquid sprayed by the spraying section 203 is preferably 20° or more and 90° or less. In a case where the spreading angle Φ falls out of this range, it is likely to be difficult to spray the liquid uniformly to the base particles having fine resin particles adhered thereto

(3-4) Film-Forming Step S3d

At the film-forming step S3d, stirring by the rotary stirring section 204 is continued at a predetermined temperature to flow the base particles having fine resin particles adhered thereto until the mixed fine resin particles adhered to the toner base particle are softened to form a film, thereby the toner base particle is coated with the resin layer.

(3-5) Collecting Step S3e

At the collecting step S3e, spraying of the liquid from the spraying section and rotation of the rotary stirring section 204 are stopped, and the capsule toner is ejected outside the apparatus from the powder collecting section 207 and is collected.

The configuration of such a toner manufacturing apparatus 201 is not limited to the above and various alterations may be added thereto. For example, the temperature regulation jacket may be provided over the outside of the powder flowing section 209 and the stirring section 208, or may be provided in a part of the outside the powder flowing section 209 or the stirring section 208. In a case where the temperature regulation jacket is provided over the outside of the powder flowing section 209 and the stirring section 208, it is possible to prevent the toner base particles from being adhered to the inner wall of the powder passage 202 more reliably.

The toner manufacturing apparatus as described above can be also composed of by combining a commercially available stirring apparatus and the spraying section. An example of the commercially available stirring apparatus provided with a powder passage and a rotary stirring section includes HYBRIDIZATION SYSTEM (trade name) manufactured by Nara Machinery Co., Ltd. By installing a liquid spraying unit in the stirring apparatus, the stirring apparatus is usable as the toner manufacturing apparatus used for the method for manufacturing a capsule toner of the invention.

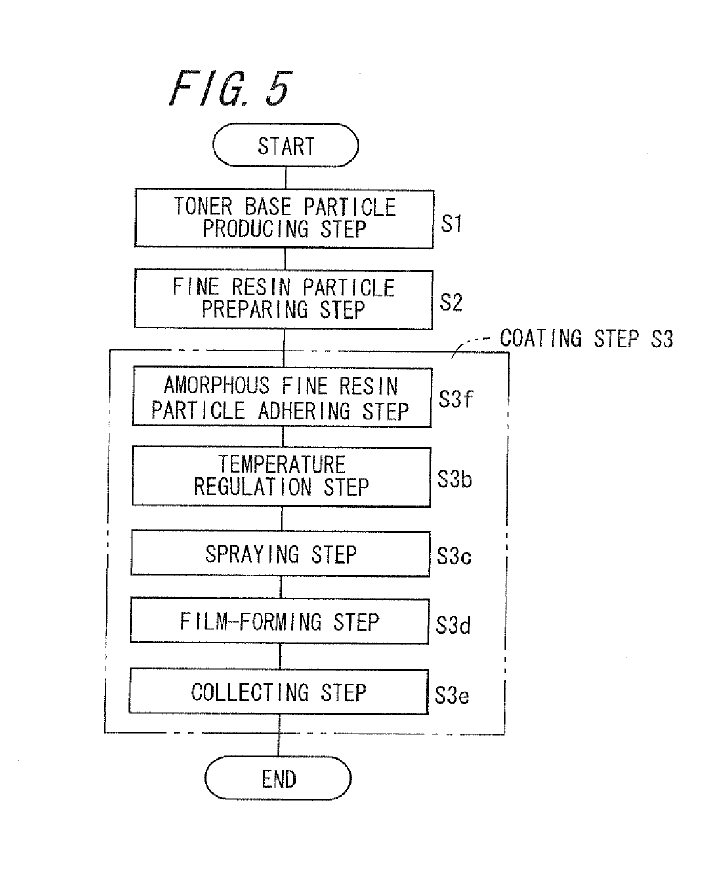

FIG. 5 is a flowchart showing a second embodiment of the method of manufacturing a capsule toner according to the invention. In the method of manufacturing the capsule toner of the invention, an amorphous fine resin particle adhering step S3f may be performed in place of the mixed fine resin particle adhering step S3a at the coating step S3 in the above-described first embodiment.

<Amorphous Fine Resin Particle Adhering Step S3f>

At an amorphous fine resin particle adhering step S31, the toner base particles produced at the toner base particle producing step S1 and the amorphous fine resin particles produced at the fine resin particle preparing step S2 are mixed by a mixer such as a Henschel mixer similarly to the mixed fine resin particle adhering step S3a to obtain base particles having amorphous fine resin particles adhered thereto in which amorphous fine resin particles are adhered to the surfaces of the toner base particles.

In a case where the amorphous fine resin particle adhering step S3f is performed in place of the mixed fine resin particle adhering step S3a at the spraying step S3, at the spraying step S3c, in place of the base particle having fine resin particles adhered thereto used in the above-described first embodiment, the base particle having amorphous fine resin particles adhered thereto produced at the amorphous fine resin particle adhering step S3f is used and in place of the liquid having an effect of plasticizing the toner base particles and the mixed fine resin particles, a crystalline polyester fine resin particle dispersion liquid is used. The crystalline polyester fine resin particle dispersion liquid prepared as follow is sprayed to the base particles having amorphous fine resin particles adhered thereto in a fluidized state from the spraying section 203 with carrier gas.

(Preparation of Crystalline Polyester Fine Resin Particle Dispersion Liquid)

The crystalline polyester fine resin particle dispersion liquid is prepared by dispersing the crystalline polyester fine resin particles produced at the fine resin particle preparing step S2 into a liquid having an effect of plasticizing the toner base particles and the amorphous fine resin particles by stirring with a commercially available homogenizer, or the like.

The liquid having an effect of not dissolving but plasticizing the toner base particles and the fine resin particles is not particularly limited, and is preferably a liquid that is easily vaporized since the liquid needs to be removed from the toner base particles and the fine resin particles after the dispersion liquid is sprayed. An example of the liquid includes a liquid containing lower alcohol. Examples of the lower alcohol include methanol, ethanol, and propanol. In a case where the liquid contains such lower alcohol, it is possible to enhance the wettability of the amorphous fine resin particles and the crystalline polyester fine resin particle with respect to the toner base particles, and adhesion of the fine resin particles over the entire surfaces or large parts of the toner base particles, deformation and film-forming are easily performed. Further, since the lower alcohol has a high vapor pressure, it is possible to further shorten the drying time at the time of removing the liquid and to suppress aggregation of the toner base particles.

The viscosity of the liquid to be sprayed is preferably 5 cP or less. The preferable liquid whose viscosity is 5 cP or less includes an alcohol. As an alcohol, a methyl alcohol, an ethyl alcohol and the like are included. These alcohols have the low viscosity and are easily vaporized, and therefore, when the liquid contains the alcohol, it is possible to spray the dispersion liquid with a minute and uniform droplet diameter without coarsening the droplet diameter of the crystalline polyester fine resin particle dispersion liquid to be sprayed from the spraying section 203. At the time of collision of the base particle having amorphous fine resin particles adhered thereto with the droplet, it is possible to further promote fining of the droplet. This makes it possible to obtain a coated toner having excellent uniformity by uniformly wetting the surfaces of the toner base particles and the amorphous fine resin particles with the dispersion liquid and applying the dispersion liquid to the surfaces of the toner base particles and the amorphous fine resin particles and softening the amorphous fine resin particles and the crystalline polyester fine resin particles by a multiplier effect of the collision energy.

A content of the crystalline polyester fine resin particles in the crystalline polyester fine resin particle dispersion liquid is preferably 1% by weight or more and 10% by weight or less. When the content of the crystalline polyester fine resin particles is less than 1% by weight, the amount of the crystalline polyester fine resin particles present in a surface layer of the resin coating layer is not sufficient, and therefore, the low temperature fixation property is not able to be exerted effectively. Moreover, when the content exceeds 10% by weight, the dispersion liquid is sprayed in a state where the crystalline polyester fine resin particles in the dispersion liquid aggregate, and therefore, the crystalline polyester fine resin particles are not dispersed uniformly in the resin coating layer. As a result, the low temperature fixation property is hampered. Furthermore, there is a possibility that a two-fluid nozzle of the spraying section 203 clogs so that the dispersion liquid is not able to be sprayed normally.

A content of the crystalline polyester in the resin coating layer is preferably 20% by weight or more and 50% by weight or less. When the content of the crystalline polyester in the resin coating layer is less than 20% by weight, the effect of melting the resin coating layer is not sufficient so that the low temperature fixation property is hampered. When the content of the crystalline polyester exceeds 50% by weight, the effect of the heating resistance by the amorphous resin is not able to be utilized, and the improvement of the blocking resistance becomes difficult.

2. Toner

A capsule toner which is an embodiment of the invention is manufactured by the above-described method of manufacturing a toner. The capsule toner obtained by the above-described method of manufacturing a toner is excellent in durability and the preservation stability since the resin layer is formed on the surface of the toner base particle to protect an enclosed component. Furthermore, by using such a capsule toner in image formation, an image with high definition and high image quality without unevenness in concentration is able to be obtained.

To the capsule toner of the invention, an external additive may be added. As the external additive, heretofore known substances can be used including silica, titanium oxide and the like. Further, it preferred that these substances are surface-treated with silicone resin, a silane coupling agent and the like. A preferable usage of the external additive is 1 part by weight to 10 parts by weight based on 100 parts by weight of the toner.

3. Developer

A developer which is an embodiment of the invention includes the capsule toner which is the above-described embodiment. The developer of the embodiment may be used as a one-component developer or a two-component developer. When used as the one-component developer, a toner is used alone without using a carrier. Moreover, by frictionally charging with a developing sleeve by using a blade or a fur blush, a toner is adhered on the sleeve so that the toner is conveyed and the image formation is performed. In the case of being used as the two-component developer, the capsule toner of the above-described embodiment is used together with a carrier.

As the carrier, heretofore known substances can be used including, for example, single or complex ferrite composed of iron, copper, zinc, nickel, cobalt, manganese, and chromium; a resin-coated carrier having carrier core particles whose surfaces are coated with coating substances; or a resin-dispersion carrier in which magnetic particles are dispersed in resin.

As the coating substance, heretofore known substances can be used including polytetrafluoroethylene, a monochloro-trifluoroethylene polymer, polyvinylidene-fluoride, silicone resin, polyester, a metal compound of di-tertiary-butylsalicylic acid, styrene resin, acrylic resin, polyamide, polyvinyl butyral, nigrosine, aminoacrylate resin, basic dyes or lakes thereof, fine silica powder, and fine alumina powder. In addition, the resin used for the resin-dispersion carrier is not limited to particular resin, and examples thereof include styrene-acrylic resin, polyester resin, fluorine resin, and phenol resin. Both of the coating substance in the resin-coated carrier and the resin used for the resin-dispersion carrier are preferably selected according to the toner components. Those substances and resin listed above may be used each alone, and two or more thereof may be used in combination.

A particle of the carrier preferably has a spherical shape or flattened shape. A particle size of the carrier is not limited to a particular size, and in consideration of forming higher-quality images, the particle size of the carrier is preferably 10 μm to 100 μm and more preferably 20 μm to 50 μm. Further, the resistivity of the carrier is preferably 10⁸ Ω·cm or more, and more preferably 10¹² Ω·cm or more.

The resistivity of the carrier is obtained as follows. At the outset, the carrier is put in a container having a cross section of 0.50 cm², thereafter being tapped. Subsequently, a load of 1 kg/cm² is applied by use of a weight to the carrier particles which are held in the container as just stated. When an electric field of 1,000 V/cm is generated between the weight and a bottom electrode of the container by application of voltage, a current value is read. The current value indicates the resistivity of the carrier. When the resistivity of the carrier is low, electric charges will be injected into the carrier upon application of bias voltage to a developing sleeve, thus causing the carrier particles to be more easily attached to the photoreceptor. In this case, the breakdown of bias voltage is more liable to occur.

Magnetization intensity (maximum magnetization) of the carrier is preferably 10 emu/g to 60 emu/g and more preferably 15 emu/g to 40 emu/g. The magnetization intensity depends on magnetic flux density of a developing roller. Under the condition of ordinary magnetic flux density of the developing roller, however, no magnetic binding force work on the carrier having the magnetization intensity less than 10 emu/g, which may cause the carrier to spatter. The carrier having the magnetization intensity larger than 60 emu/g has bushes which are too large to keep the non-contact state with the image bearing member in the non-contact development or to possibly cause sweeping streaks to appear on a toner image in the contact development.

A use ratio of the toner to the carrier in the two-component developer is not limited to a particular ratio, and the use ratio is appropriately selected according to kinds of the toner and carrier. To take the resin-coated carrier (having density of 5 g/cm² to 8 g/cm²) as an example, the usage of the toner may be determined such that a content of the toner in the developer is 2% by weight to 30% by weight and preferably 2% by weight to 20% by weight of the total amount of the developer. Further, in the two-component developer, coverage of the carrier with the toner is preferably 40% to 80%.

### EXAMPLES

Hereinafter, referring to examples and comparative examples, the invention will be specifically described. In the following description, unless otherwise noted, “parts” and “%” represent “parts by weight” and “% by weight” respectively. A softening temperature and a glass transition temperature of the resin, a melting point of the release agent, a volume average particle size and a coefficient of variation of the toner base particles and a crystalline index and a volume median particle size (D50) of the fine resin particles in the examples and the comparative examples were measured as follows.

[Softening Temperature of Resin]

Using a flow characteristic evaluation apparatus (trade name: FLOW TESTER CFT-1000, manufactured by Shimadzu Corporation), 1 g of specimen was heated temperature increasing rate of 6° C./min, and a load of 20 kgf/cm² (19.6×10⁵ Pa) is applied thereto. A temperature at the time when a half-amount of the specimen was pushed out of a dye (nozzle opening diameter of 1 mm and length of 1 mm) was obtained as the softening temperature (Tₘ).

[Glass Transition Temperature of Resin]

Using a differential scanning calorimeter (trade name: DSC220, manufactured by Seiko Instruments & Electronics Ltd.), 1 g of a specimen was heated at a temperature rising rate of 10° C./min to measure a DSC curve based on the Japanese Industrial Standard (JIS) K 7121-1987. For the obtained DSC curve, an endothermic peak is measured.

A maximum peak temperature which is a peak temperature on the side of the highest temperature of the endothermic peak to be observed serves as a melting point when a difference from a softening temperature is within 20° C. and caused by a glass transition when the difference from the softening temperature exceeds 20° C. The temperature at the intersection of a straight line in which a base line on the side of higher temperatures than the endothermic peak corresponding to the glass transition is extended to the side of lower temperatures, and a tangent line drawn at a point where the gradient becomes maximum for a curve from a rising part of the peak to the apex served as the glass transition temperature (Tg).

In the case where a binder resin contains an amorphous resin other than crystalline polyester or the crystalline polyester contains an amorphous part, a peak temperature observed at a lower temperature than an endothermic maximum peak temperature or the temperature at the intersection of an extended line of the base line at the endothermic maximum peak temperature or lower and a tangent line indicating the maximum inclination from the rising part of the peak to the apex served as the glass transition temperature.

[Melting Point of Release Agent]

Using a differential scanning calorimeter (trade name: DSC220, manufactured by Seiko Instruments & Electronics Ltd.), 1 g of a specimen was heated from a temperature of 20° C. up to 200° C. at a temperature rising rate of 10° C. per minute, and then an operation of rapidly cooling down from 200° C. to 20° C. was repeated twice, thus measuring a DSC curve. A temperature at an endothermic peak corresponding to the melting on the DSC curve measured at the second operation, served as the melting point of the release agent.

[Volume Average Particle Size and Coefficient of Variation of Toner Base Particles]

To 50 ml of an electrolytic solution (trade name: ISOTON-II, manufactured by Beckman Coulter Inc.), 20 mg of a specimen and 1 ml of sodium alkylether sulfate ester were added, and thus-obtained admixture was subjected to dispersion processing of an ultrasonic distributor (trade name: desktop two-frequency ultrasonic cleaner VS-D100, manufactured by AS ONE Corporation) for 3 minutes at a frequency of 20 kHz, which served as a specimen for measurement. As to this specimen for measurement, a particle size distribution measuring apparatus (trade name: Multisizer 3, manufactured by Beckman Coulter Inc.) was used to perform measurement under conditions of an aperture diameter: 100 μm, and the number of particles to be measured: 50,000 counts, and from the volume particle size distribution of the specimen particles, the volume average particle size and a standard deviation in the volume particle size distribution were obtained. A coefficient of variation (CV value, %) was calculated based on the following formula.

CV value (%)=(Standard deviation in volume particle size distribution/Volume average particle size)×100

[Crystalline Index of Fine Resin Particle]

In the same manner as a measurement method of the glass transition temperature, a temperature corresponding to an endothermic maximum peak temperature (Tc) was measured. Using a softening temperature (Tm) measured according to the above description and the temperature corresponding to the endothermic maximum peak temperature (Tc), a crystalline index was measured from the following formula.

Crystalline index=Tm/Tc

[Volume Median Particle Size of Fine Resin Particles]

A volume median particle size of the fine resin particles was measured as a particle size of 50% frequency (median size) on a volumetric basis with the use of a laser diffraction/scattering particle size distribution analyzer (trade name: LA-920, manufactured by Horiba, Ltd.).

Examples 1 to 9 were performed based on the first embodiment of the method of manufacturing a capsule toner according to the invention shown in FIG. 1.

### Example 1

### Toner Base Particle Producing Step S1

| | |
|---|---|
| Polyester resin (trade name: TUFTONE, manufactured | 85 parts |
| by Kao Corporation, glass transition temperature: 60° C., | |
| softening temperature: 138° C.) | |
| C.I. Pigment Blue 15:35 | 5 parts |
| Release agent (trade name: carnauba wax, | 8 parts |
| manufactured by Toa Kasei Co., Ltd., melting point: 82° C.) | |
| Charge control agent (trade name: BONTRON E84, | 2 parts |
| manufactured by Orient Chemical Industries Ltd.) | |

After pre-mixing the above raw materials by a Henschel mixer for 3 minutes, by using a twin-screw extruder (trade name: PCM-30, manufactured by Ikegai, Ltd.), the mixture was melt-kneaded at a set cylinder temperature of 110° C., a barrel rotating number of 300 revolutions per minute (300 rpm), and a raw material supplying rate of 20 kg/hour. The resultant melt kneaded product, after being cooled on a cooling belt and then coarsely pulverized by means of a speed mill having a screen having a diameter of 2 mm, was finely pulverized by means of a jet pulverizer (trade name: IDS-2, manufactured by Nippon Pneumatic MFG. Co., Ltd.), and further classified with an Elbow-Jet classifier (trade name, manufactured by Nittetsu Mining Co., Ltd.), thereby producing a toner base particle having a volume average particle size of 6.9 μm, a coefficient of variation of 22, a softening temperature of 116° C. and a glass transition temperature of 55° C.

[Fine Resin Particle Producing Step S2]

<Production of Amorphous Polyester Fine Resin Particle A>

An amorphous polyester resin 1 was obtained by the reaction of polyoxypropylene (2,3)-2,2-bis(4-hydroxyphenyl)propane, ethylene glycol, terephthalic acid, isophthalic acid, and trimellitic acid anhydride.

The amorphous polyester resin 1 was dissolved in methyl ethyl ketone, and to a solution thereof, an anion surfactant (dodecyl sodium sulfate) aqueous solution was added, which was emulsified with a mechanical disperser (trade name: CLEARMIX, manufactured by M Technique Co., Ltd.). From the obtained emulsified product, methyl ethyl ketone was depressurized and distilled, thereby obtaining an amorphous polyester fine resin particle A (volume median particle size of 0.2 μm, softening temperature of 122° C., endothermic maximum peak temperature of 64° C., glass transition temperature of 64° C. and crystalline index of 1.91). The thus-obtained product was further freeze-dried and resulted in dried powder.

<Production of Crystalline Polyester Fine Resin Particle B>

In a four-necked flask whose volume is 5 liter equipped with a nitrogen introduction tube, a dewatering conduit, an agitator and a thermocouple, 300 g of 1,6-hexanediol of 300 g, 812 g of fumaric acid, 4 g of dibutyltin oxide and 1 g of hydroquinone were put to be reacted at 160° C. for 5 hours, followed by raising the temperature to 200° C. to be reacted for 1 hour, and further reacted at 8.3 kPa until reaching a desired crystalline index so that a crystalline polyester resin 1 was obtained.

The crystalline polyester resin 1 was dissolved in methyl ethyl ketone, and to a solution thereof, an anion surfactant (dodecyl sodium sulfate) aqueous solution was added, which was emulsified with a mechanical disperser (trade name: CLEARMIX, manufactured by M Technique Co., Ltd.). From the obtained emulsified product, methyl ethyl ketone was depressurized and distilled, thereby obtaining a crystalline polyester fine resin particle B (volume median particle size of 0.15 μm, softening temperature of 109° C., endothermic maximum peak temperature of 113° C., glass transition temperature of 17° C. and crystalline index of 0.96). The thus-obtained product was further freeze-dried and resulted in dried powder.

[Coating Step S3]

<Preparation of Mixed Fine Resin Particles>

Into a Henschel mixer 20B (manufactured by Mitsui Mining Co., Ltd.), 500 g of the amorphous polyester fine resin particle A and 500 g of the crystalline polyester fine resin particle B were inputted to be mixed for 3 minutes at peripheral speed of 40 m/sec of a stirring blade and mixed fine resin particles A were prepared. A content of the crystalline polyester fine resin particle in the mixed fine resin particles is 50% by weight. Additionally, a volume median particle size ratio of the crystalline polyester fine resin particle relative to the amorphous polyester fine resin particle is 75%.

<Production of Base Particle Having Mixed Fine Resin Particles Adhered Thereto>

Into the Henschel mixer 20B (manufactured by Mitsui Mining Co., Ltd.), 100 parts of the toner base particle and 10 parts of the mixed fine resin particles A were inputted to be mixed for 3 minutes at peripheral speed of 40 m/sec of the stirring blade and a base particle having mixed fine resin particles adhered thereto was produced.

The base particles having mixed fine resin particles adhered thereto were input into an apparatus in which a two-fluid nozzle is installed in a Hybridization system (trade name: NHS-1 Model, manufactured by Nara Machinery Co., Ltd.) in conformity with the apparatus shown in FIG. 2, to be accumulated for 3 minutes at rotating speed of 8000 rpm, followed by being sprayed by ethanol.

As the liquid spraying unit, the one to which a liquid feeding pump (trade name: SP11-12, manufactured by FLOM Co., Ltd.) and a two-fluid nozzle are connected, so as to be able to quantitatively feed the liquid, is able to be used. The spraying speed of liquid and the exhausting speed of liquid gas are able to be observed by using a commercially-available gas detector (trade name: XP-3110, manufactured by New Cosmos Electric Co., Ltd.)

The temperature regulation jacket was provided over the entire surface of the powder flowing section and the wall face of the stirring section. A temperature sensor was installed in the powder passage, and a temperature of the powder flowing section and the stirring section was regulated to 45° C. In the above apparatus, a peripheral speed in the outermost peripheral of the rotary stirring section of the Hybridization system was 100 m/sec at the fine resin particle adhering step to the surface of toner base particles. The peripheral speed was also 100 m/sec at the spraying step and the film-forming step. Moreover, an installation angle of the two-fluid nozzle was set so that an angle formed by the liquid spraying direction and the powder flowing direction (hereinafter referred to as “spraying angle”) is in parallel (0°).

Ethanol was sprayed for 40 minutes at spraying speed of 0.5 g/min and at an air flowing amount of 5 L/min, and film-forming of the mixed fine resin particles A was performed on the surface of the toner base particle. Spraying of ethanol was stopped, followed by stirring for 5 minutes, and a capsule toner of Example 1 (volume average particle size: 7.2 μm, coefficient of variation: 25) was obtained. At this time, an exhaust concentration of the liquid exhausted through a through-hole and the gas exhausting section was about 1.4 Vol %, which was stable. Additionally, the air flowing amount to be fed into apparatus was, by adjusting the air flowing amount to be fed into the apparatus from the rotating shaft section to 5 L/min, set to 10 L/min adding the air flowing amount from the two-fluid nozzle.

In 100 parts of the capsule toner produced in this manner, 2 parts of hydrophobic silica particles (manufactured by Nippon Aerosil Co., Ltd., primary particle size of 12 nm, HMDS treatment) as an external additive were inputted, and mixed for 1 minute at peripheral speed of 30 m/second of the stirring blade to be resulted in the toner of Example 1.

<Production of Two-Component Developer>

The toner of Example 1 and a ferrite core carrier having a volume average particle size of 60 μm were mixed so that the toner concentration became 7%, and the two-component developer of Example 1 was produced.

### Example 2

The toner and the developer of Example 2 were obtained in the same manner as Example 1 except that in preparation of the mixed fine resin particles, 800 g of the amorphous polyester fine resin particle A and 200 g of the crystalline polyester fine resin particle B were used.

### Example 3

The toner and the developer of Example 3 were obtained in the same manner as Example 1 except that in preparation of the mixed fine resin particles, 900 g of the amorphous polyester fine resin particle A and 100 g of the crystalline polyester fine resin particle B were used.

### Example 4

The toner and the developer of Example 4 were obtained in the same manner as Example 1 except that in preparation of the mixed fine resin particles, 400 g of the amorphous polyester fine resin particle A and 600 g of the crystalline polyester fine resin particle B were used.

### Example 5

### Production of Amorphous Styrene-Acrylic Copolymer Fine Resin Particle C

Styrene, acrylic acid and butyl acrylate were polymerized so that an amorphous styrene-acrylic copolymer fine resin particle C (volume median particle size: 0.18 μm, softening temperature: 138° C., endothermic maximum peak temperature: 69° C., glass transition temperature: 69° C., crystalline index: 2.00) was obtained. The thus-obtained product was further freeze-dried and resulted in dried powder.

The toner and the developer of Example 5 were obtained in the same manner as Example 1 except that in preparation of the mixed fine resin particles, the amorphous styrene-acrylic copolymer fine resin particle C was used in place of the amorphous polyester fine resin particle A.

### Example 6

The toner and the developer of Example 6 were obtained in the same manner as Example 1 except that ethanol was not sprayed.

### Example 7

The toner and the developer of Example 7 were obtained in the same manner as Example 1 except that the mixed fine resin particles were not prepared, and 5 parts of the amorphous polyester fine resin particle A and 5 parts of the crystalline polyester fine resin particle B were input directly in the Henschel mixer.

### Example 8

### Production of Crystalline Polyester Fine Resin Particle D

The crystalline polyester fine resin particle D (volume median particle size: 0.18 μm, softening temperature: 109° C., endothermic maximum peak temperature: 113° C., glass transition temperature: 17° C., crystalline index: 0.96) was obtained in the same manner as the production of the crystalline polyester fine resin particle B except that the emulsification time was shortened. The thus-obtained product was further freeze-dried and resulted in dried powder.

The toner and the developer of Example 8 were obtained in the same manner as Example 5 except that in preparation of the mixed fine resin particles, the crystalline polyester fine resin particle D was used in place of the crystalline polyester fine resin particle B.

### Example 9

### Production of Crystalline Polyester Fine Resin Particle E

The crystalline polyester fine resin particle E (volume median particle size: 0.22 μm, softening temperature: 109° C., endothermic maximum peak temperature: 113° C., glass transition temperature: 17° C., crystalline index: 0.96) was obtained it the same manner as the production of the crystalline polyester fine resin particle B except that the emulsification time was shortened. The thus-obtained, product was further freeze-dried and resulted in dried powder.

The toner and the developer of Example 9 were obtained in the same manner as Example 5 except that in preparation of the mixed fine resin particles, the crystalline polyester fine resin particle E was used in place of the crystalline polyester fine resin particle B.

Examples 10 and 11 were performed based on the second embodiment of the method of manufacturing the capsule toner according to the invention shown in FIG. 5. Note that, description will be given for only the points that are different from Example 1 in the below.

### Example 10

At the coating step S3, the mixed fine resin particles were not produced, 100 parts of the toner base particle and 5 parts of the amorphous polyester fine resin particle A were mixed and a base particle having amorphous fine resin particle adhered thereto was produced in place of the base particle having mixed fine resin particles adhered thereto. The mixing was performed for 3 minutes at peripheral speed of 40 m/sec of the stirring blade with the use of the Henschel mixer 20B (manufactured by Mitsui Mining Co., Ltd.).

<Preparation of Crystalline Polyester Fine Resin Particle Dispersion Liquid>

The crystalline polyester fine resin particle B was dispersed in ethanol and a crystalline polyester fine resin particle dispersion liquid (content of the crystalline polyester fine resin particle: 6.25% by weight) was prepared.

The toner and the developer of Example 10 were obtained in the same manner as Example 1 except that the base particles having the amorphous fine resin particles adhered thereto were input into the apparatus in which the two-fluid nozzle is installed in the Hybridization system that is used in Example 1 to be accumulated at rotating speed of 8000 rpm for 3 minutes, replacing with the base particle having mixed fine resin particles adhered thereto, thereafter 80 parts of the crystalline polyester fine resin particle dispersion liquid in place of the ethanol were sprayed at spraying speed of 2 g/min and 5 parts of the crystalline polyester fine resin particle were added to 100 parts of the toner base particle.

### Example 11

The toner and the developer of Example 11 were obtained in the same manner as Example 10 except that at the coating step S3, 8 parts of the amorphous polyester fine resin particle A in place of 5 parts of the amorphous polyester fine resin particle A were mixed with 100 parts of the toner base particle to produce the base particle having the amorphous fine resin particle adhered thereto, the crystalline polyester fine resin particle dispersion liquid was prepared so that the content of the crystalline polyester fine resin particles becomes 2.5% by weight and 2 parts of the crystalline polyester fine resin particle were added to 100 parts of the toner base particle.

### Comparative Example 1

The coating step S3 was not performed, and the toner and the developer of Comparative Example 1 were obtained using by only toner base particles.

### Comparative Example 2

The toner and the developer of Comparative Example 2 were obtained in the same manner as Example 1 except that the mixed fine resin particles were not prepared, and 10 parts of the crystalline polyester fine resin particle B were inputted based on 100 parts of the toner base particle.

### Comparative Example 3

The toner and the developer of Comparative Example 3 were obtained in the same manner as Example 1 except that the mixed fine resin particles were not prepared, and 10 parts of the amorphous styrene-acrylic copolymer fine resin particle C were inputted based on 100 parts of the toner base particle.

The toners of Examples 1 to 11 and Comparative Examples 1 to 3 were evaluated as follows.

[Blocking Resistance]

The two-component developers obtained in Examples 1 to 11 and Comparative Examples 1 to 3 were filled in a commercially-available copier (trade name: MX-2300G, manufactured by Sharp Corporation), respectively, and in a state where an image was adjusted so as not to be developed on a photoreceptor, only a developing machine was continuously operated for 5 hours under a constant temperature of 20° C. and eccentricity of the developer and the presence/absence of occurrence of the aggregation were confirmed. The eccentricity of the developer occurs for a conveyance shaft of the developer due to the reduction in conveyance performance of the developer in the developing tank along with the reduction in flowability of the toner. The eccentricity of the developer causes heat generation along with the operation to increase when conveyance torque increases, and a part of the developer is fused and fixed so that the aggregation is generated.

An evaluation standard of the blocking resistance is as follows.

Good (Favorable): No occurrence of the eccentricity of the developer.

Not bad (Normal): Occurrence of the eccentricity of the developer is found but occurrence of the aggregation is not found.

Poor (No good): Occurrence of the aggregation is found.

[Low Temperature Fixation Property]

The two-component developers obtained in Examples 1 to 11 and Comparative Examples 1 to 3 were filled in the above-described copier, respectively, and a surface temperature of the heating roller was raised from 130° C. to 220° C. at 5° C. intervals to form an image so that a lower-limit temperature in which a low-temperature offset does not occur served as a minimum fixation temperature.

Further, for a developer with use of a toner which has not been capsulated (corresponding to the toner of Comparative Example 1), the minimum fixation temperature of an image was measured similarly, which a difference from the minimum fixation temperature caused by each of the above-described developers was calculated and the low temperature fixation property was evaluated from those values as follows.

Excellent (Very favorable): The difference of the minimum fixation temperature is 5° C. or less.

Good (Favorable): The difference of the minimum fixation temperature exceeds 5° C. and 15° C. or less.

Not had (Normal): The difference of the minimum fixation temperature exceeds 15° C. and 25° C. or less.

Poor (No good): The difference of the minimum fixation temperature exceeds 25° C.

[Comprehensive Evaluation]

Comprehensive evaluation was performed by the following standard, adding the evaluation results of the blocking resistance and the low temperature fixation property.

Good (Favorable): All of the results correspond to “Excellent” or “Good”.

Not bad (Normal): Any of the results correspond to “Not bad” but not to “Poor”.

Poor (No good): Any of the results correspond to “Poor”.

Fine resin particle used for the toners of Examples 1 to 11 and Comparative Examples 1 to 3 are shown in a table 1 and the evaluation result of each toner is shown in a table 2.

TABLE 1

| | Amorphous fine resin particle | | | Crystalline polyester fine resin particle | | | | |
|---|---|---|---|---|---|---|---|---|
| | | Particle size | Input amount | | Particle size | Input amount | Content | Particle size ratio |
| | Resin | (μm) | (g) | Resin | (μm) | (g) | (% by weight) | (%) |
| Example 1 | A | 0.2 | 500 | B | 0.15 | 500 | 50 | 75 |
| Example 2 | A | 0.2 | 800 | B | 0.15 | 200 | 20 | 75 |
| Example 3 | A | 0.2 | 900 | B | 0.15 | 100 | 10 | 75 |
| Example 4 | A | 0.2 | 400 | B | 0.15 | 600 | 60 | 75 |
| Example 5 | C | 0.18 | 500 | B | 0.15 | 500 | 50 | 83 |
| Example 6 | A | 0.2 | 500 | B | 0.15 | 500 | 50 | 75 |
| Example 7 | A | 0.2 | — | B | 0.15 | — | 50 | 75 |
| Example 8 | C | 0.18 | 500 | D | 0.18 | 500 | 50 | 100 |
| Example 9 | C | 0.18 | 500 | E | 0.22 | 500 | 50 | 122 |
| Example 10 | A | 0.2 | — | B | 0.15 | — | 50 | 75 |
| Example 11 | A | 0.2 | — | B | 0.15 | — | 20 | 75 |
| Comparative | — | — | — | — | — | — | — | — |
| Example 1 | | | | | | | | |
| Comparative | — | — | — | B | 0.15 | — | 100 | — |
| Example 2 | | | | | | | | |
| Comparative | C | 0.18 | — | — | — | — | 0 | — |
| Example 3 | | | | | | | | |

TABLE 2

| | | Low temperature fixation property | | | |
|---|---|---|---|---|---|
| | Blocking resistance | Minimum fixation temperature | Difference of temperature | | Comprehensive |
| | Evaluation | (° C.) | (° C.) | Evaluation | evaluation |
| Example 1 | Good | 170 | 5 | Excellent | Good |
| Example 2 | Good | 180 | 15 | Good | Good |
| Example 3 | Good | 190 | 25 | Not bad | Not bad |
| Example 4 | Not bad | 170 | 5 | Excellent | Not bad |
| Example 5 | Good | 170 | 20 | Not bad | Not bad |
| Example 6 | Not bad | 185 | 15 | Good | Not bad |
| Example 7 | Not bad | 175 | 10 | Good | Not bad |
| Example 8 | Good | 180 | 15 | Good | Good |
| Example 9 | Not bad | 190 | 25 | Not bad | Not bad |
| Example 10 | Good | 165 | 0 | Excellent | Good |
| Example 11 | Good | 170 | 5 | Excellent | Good |
| Comparative | Poor | 165 | 0 | Excellent | Poor |
| Example 1 | | | | | |
| Comparative | Poor | 165 | 0 | Excellent | Poor |
| Example 2 | | | | | |
| Comparative | Good | 200 | 35 | Poor | Poor |
| Example 3 | | | | | |

In the toners of Examples 1, 2, 8, 10 and 11, both the blocking resistance and the low temperature fixation were favorable or very favorable.

In the toners of Examples 3 and 5, the blocking resistance was favorable, and the low temperature fixation property was normal. It is considered that a less content of the crystalline polyester resin caused the low temperature fixation property to deteriorate in the toner of Example 3. Moreover, in the toner of Example 5, a particle size ratio of the crystalline polyester resin relative to the amorphous polyester fine resin particle is not much preferable so that it is considered that an effect of the low temperature fixation brought by the crystalline polyester resin has not been exerted sufficiently.

In the toners of Examples 4, 6 and 7, the low temperature fixation property was favorable or very favorable, and the blocking resistance was normal. It is considered that in the toner of Example 4, a large content of the crystalline polyester resin caused the blocking resistance to deteriorate, and it is considered that in the toner of Example 6, the film-forming of the mixed fine resin particles is not sufficiently performed on the surface of the toner base particle since ethanol is not sprayed so that no formation of a uniform coating layer causes the deterioration of the blocking resistance. Further, it is considered that in the toner of Example 7, the mixed fine particle is not prepared, and therefore, no formation of the uniform coating layer causes the deterioration of the blocking resistance.

In the toner of Example 9, the blocking resistance and the low temperature fixation property were both normal. It is considered that this is caused by a large particle size ratio of the crystalline polyester resin relative to the amorphous polyester fine resin particle.

In the toners of Comparative Examples 1 and 2, the low temperature fixation property was very favorable, and the blocking resistance was no good. It is considered that in the toner of Comparative Example 1, such a result was caused by no resin coating layers, and in the toner of Comparative Example 2, such a result was caused by which the resin coating layer was consisted of only the crystalline polyester resin.

In the toner of Comparative Example 3, the blocking resistance was favorable, and the low temperature fixation property was no good. It is considered that this was caused by which the crystalline polyester resin is not contained in the resin coating layer.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A capsule toner comprising:
a toner base particle containing a binder resin and a colorant; and
a resin coating layer containing a crystalline polyester resin and an amorphous resin, the resin coating layer coating a surface of the toner base particle.

2. A method of manufacturing a capsule toner, comprising:
a mixed fine resin particle adhering step of adhering mixed fine resin particles composed of a crystalline polyester fine resin particle and an amorphous fine resin particle to a surface of a toner base particle containing a binder resin and a colorant to form a base particle having fine resin particles adhered thereto;
a spraying step of spraying a liquid that plasticizes the mixed fine resin particles and the toner base particle to the base particle having fine resin particle adhered thereto made to be in a fluidized state; and
a film-forming step of performing the film-forming of the mixed fine resin particles by impact force to form a resin coating layer on the surface of the toner base particle.

3. The method of claim 2, wherein the mixed fine resin particle adhering step includes a step of preparing the mixed fine resin particles by mixing the crystalline polyester fine resin particle and the amorphous fine resin particle, and a step of mixing the toner base particle and the mixed fine resin particles to form a base particle having fine resin particle adhered thereto in which the mixed fine resin particles are adhered on the surface of the toner base particle.

4. The method of claim 2, wherein a volume median particle size of the crystalline polyester fine resin particles is smaller than a volume median particle size of the amorphous fine resin particles.

5. The method of claim 3, wherein the mixed fine resin particles contain 20% by weight or more and 50% weight or less of the crystalline polyester fine resin particle.

6. A method of manufacturing a capsule toner, comprising:
an amorphous fine resin particle adhering step of adhering an amorphous fine resin particle on a surface of a toner base particle containing a binder resin and a colorant to form a base particle having an amorphous fine resin particle adhered thereto;
a spraying step of spraying a dispersion liquid to the base particle having the amorphous fine resin particle adhered thereto made to be in a fluidized state, the dispersion liquid being prepared by dispersing a crystalline polyester fine resin particle into a liquid that plasticizes the amorphous fine resin particle and the toner base particle; and
a film-forming step of performing the film-forming of the amorphous fine resin particle and the crystalline polyester fine resin particle by impact force to form a resin coating layer on the surface of the toner base particle.
